(19) United States
(12) Patent Application Publication
(10) Pub. No.: US 2013/0006790 A1
(43) Pub. Date: Jan. 3, 2013

(54) SYSTEM AND METHOD FOR PLANNING LAYOUT OF A RETAIL STORE

(75) Inventors: Jason B. Raskin, Santa Clara, CA (US); Erik Hadden, Cupertino, CA (US); Jonathan M. Van Keulen, San Jose, CA (US); Kuochun Chin, Foster City, CA (US)

(73) Assignee: Apple Inc., Cupertino, CA (US)

(21) Appl. No.: 13/607,588

(22) Filed: Sep. 7, 2012

Related U.S. Application Data
(63) Continuation-in-part of application No. 13/476,756, filed on May 21, 2012.
(60) Provisional application No. 61/488,696, filed on May 20, 2011.

(51) Int. Cl. G06Q 30/00

(52) U.S. Cl. 705/26.1

(57) ABSTRACT

An interactive map for a retail store floor to determine product placement is disclosed. The interactive floor map can be customized for each retail store using custom-designed or pre-defined fixture blocks. Each fixture block includes a display surface, a representation of a product being displayed, and representation of its associated signage. Multiple products can be included in a fixture block and multiple fixture blocks can then be used to complete the interactive floor map for a retail store. Notes can be added at each level of creating the interactive floor map to add details that may be product, fixture, fixture block, and/or location specific. Also, an effective date and time for an interactive floor map for a store can be managed based on the date and time associated with a local time zone where the store is located.

### CROSS-REFERENCES TO RELATED APPLICATIONS

This application is a continuation-in-part of U.S. patent application Ser. No. 13/476,756 filed on May 21, 2012, which in turn claims priority to U.S. Provisional Application No. 61/488,696 filed on May 20, 2011, the entire disclosures of which are incorporated by reference herein for all purposes.

### BACKGROUND

Retail customers sometimes find it hard to obtain the information they want about products they are considering for purchase. Often, the signage included in store displays only mentions a few product features, and these may not be the features of most interest to a particular customer. To avoid this, some retailers attempt to cram information onto a sign of limited size, making it hard to read. Others provide product brochures or other printed material that the customer is invited to read or take.

In addition, retailers do not always keep signage up to date. For example, when a sale commences, the reduced prices may not be posted immediately on all signs, and when a sale ends, the sale-price signs might not be immediately removed, or some of the “sale” signs may be inadvertently left behind. As a result, the customer can be confused as to the actual price of the product. Further, in an era where products are frequently updated, information included in signs and/or printed materials may quickly be out of date.

It is difficult to manage design of floor plans for retail locations world-wide using a centralized design tool. Conventionally, layout for a retail store is managed locally on an individual basis. Also, retail stores in similar geographic area can vary in their floor layout and product placement. Historically, product placement in a retail store has varied according to the demographics of the population that visits the store. There is currently no mechanism for designing a retail store on a world-side basis that provides a consistent shopping experience to a consumer.

### SUMMARY

Embodiments of the present invention relate to systems and methods for providing dynamic signage, e.g., in a retail store or other sales environment. A dynamic signage device (which can be, e.g., a tablet computer) is associated with a product and capable of presenting information about the product to a customer in an interactive manner, e.g., by providing an interface that allows the user to selectably view various information screens. The device can automatically check for updated product information and modify its display based on the updated product information. In some embodiments, the customer can also use the dynamic signage device to request assistance from an employee or indicate a desire to purchase the associated product.

Some embodiments further provide for coordinated management of multiple dynamic signage devices. For example, a dynamic signage device can be identified by reference to its location, e.g., at a particular position within a particular fixture in a particular store within a chain of stores owned or managed by a corporate entity. A server operated by the corporate entity can associate the location with a product being displayed at that location; based on that association, the server can deliver current information to the dynamic signage device. For instance, price information for the associated product can be updated. Updates to the product information can be coordinated across multiple dynamic signage devices within a store or across multiple stores. In addition, if the product being displayed at the location associated with the dynamic signage device is changed (e.g., due to a product upgrade or rearrangement of product displays within the store), the device can be automatically updated with information for the new product.

Other embodiments of the present invention relate to a system and method of managing layout of a retail store. The system uses pre-defined as well as custom defined fixtures and fixture blocks to build display units. For each fixture and/or fixture block, a designer can add custom notes that may be global or local to a particular location associated with the store layout currently being designed.

The following detailed description together with the accompanying drawings will provide a better understanding of the nature and advantages of the present invention.

### BRIEF DESCRIPTION OF THE DRAWINGS

FIGS. 1A-1B illustrate a dynamic signage system in a retail store according to an embodiment of the present invention.

FIG. 2 is a simplified block diagram of a dynamic signage device according to an embodiment of the present invention.

FIG. 3 is a simplified block diagram of a retail network according to an embodiment of the present invention.

FIG. 4 illustrates an in-store network according to an embodiment of the present invention.

FIG. 5 is a flow diagram of a process for initializing a dynamic signage device according to an embodiment of the present invention.

FIG. 6 is a flow diagram of a process for entering retail mode in a dynamic signage device according to an embodiment of the present invention.

FIG. 7 is a flow diagram of a process for associating a dynamic signage device with a product based on the location of the dynamic signage device according to an embodiment of the present invention.

FIGS. 8A-8B illustrate an interactive floor map according to an embodiment of the present invention.

FIG. 9 is a flow diagram of a process for pushing an update out to a dynamic signage device according to an embodiment of the present invention.

FIG. 10 is a flow diagram of a process for pulling updated information to a dynamic signage device according to an embodiment of the present invention.

FIG. 11 is a flow diagram of a process that can be used for interactive presentation of product information according to an embodiment of the present invention.

FIG. 12 illustrates a product home screen according to an embodiment of the present invention.

FIG. 13 illustrates a feature information screen according to an embodiment of the present invention.

FIG. 14 illustrates a product comparison page according to an embodiment of the present invention.

FIG. 15 illustrates a carrier information screen according to an embodiment of the present invention.

FIG. 16 illustrates a support-information page according to an embodiment of the present invention.

FIG. 17 illustrates an assistance-request screen according to an embodiment of the present invention.

FIG. 18 illustrates a hierarchical structure for managing product data according to an embodiment of the present invention.

FIG. 19 is a flow diagram of a process that can be used to build an interactive floor map according to an embodiment of the present invention.

FIG. 20 illustrates a graphical user interface (GUI) for defining a display surface according to an embodiment of the present invention.

FIG. 21 illustrates a GUI for creating a fixture according to an embodiment of the present invention.

FIG. 22 illustrates a GUI for constructing a floor map using fixtures according to an embodiment of the present invention.

FIG. 23 is a flow diagram of a process for updating a store layout using an in-store floor map application according to an embodiment of the present invention.

FIG. 24 illustrates a user interface for viewing a floor map that is to be implemented according to an embodiment of the present invention.

FIG. 25 illustrates a user interface showing fixture details for a floor map according to an embodiment of the present invention.

FIG. 26 illustrates another user interface showing fixture details according to an embodiment of the present invention.

FIG. 27 illustrates a user interface showing fixture details in an elevation view according to an embodiment of the present invention.

FIG. 28 illustrates a pop-up window that can appear when the user taps on a product group shown in the user interface of FIG. 27 according to an embodiment of the present invention.

FIG. 29 illustrates notes that can be associated with an element of a floor map according to an embodiment of the present invention.

FIG. 30 illustrates a user interface showing menu to enable adding notes to a product set according to an embodiment of the present invention.

FIG. 31 illustrates a user interface showing menu to enable adding notes to a fixture according to an embodiment of the present invention.

FIG. 32 illustrates a user interface showing menu to enable adding notes to a fixture block according to an embodiment of the present invention.

FIG. 33 illustrates a user interface showing menu to enable adding notes to an event according to an embodiment of the present invention.

FIG. 34 illustrates a user interface showing how a custom note is displayed in the planogram according to an embodiment of the present invention.

FIG. 35 illustrates a user interface showing menu to enable event management for go-live date in a particular time zone according to an embodiment of the present invention.

### DETAILED DESCRIPTION

Embodiments of the present invention relate to systems and methods for providing dynamic signage, e.g., in a retail store or other sales environment. A dynamic signage device (which can be, e.g., a tablet computer) is associated with a product and capable of presenting information about the product to a customer in an interactive manner, e.g., by providing an interface that allows the user to selectably view various information screens. The device can automatically check for updated product information and modify its display based on the updated product information. In some embodiments, the customer can also use the dynamic signage device to request assistance from an employee or indicate a desire to purchase the associated product.

Some embodiments further provide for coordinated management of multiple dynamic signage devices. For example, a dynamic signage device can be identified by reference to its location, e.g., at a particular position within a particular fixture in a particular store within a chain of stores owned or managed by a corporate entity. A server operated by the corporate entity can associate the location with a product being displayed there; based on that association, the server can deliver current information to the dynamic signage device. For instance, price information for the associated product can be updated. Updates to the product information can be coordinated across multiple dynamic signage devices within a store or across multiple stores.

In addition, if the product being displayed at the location associated with the dynamic signage device is changed (e.g., due to a product upgrade or rearrangement of product displays within the store), the device can be automatically updated with information for the new product.

Some embodiments of the present invention provide techniques for designing and managing a floor layout for a retail store. The retail store floor has a certain shape and area.

Multiple fixture blocks can be arranged on the retail store floor in order to display one or more products. Each fixture block includes one or more fixtures. Each fixture includes a product set and its associated dynamic signage. The process of building a fixture block may include selecting at least one product set and its associated dynamic signage to generate a fixture. Generating one more of such fixtures and organizing them into a fixture block. Thereafter the technique includes arranging one or more fixture blocks on a floor of a retail store layout to complete the design of the retail store floor.

The following sections describe a dynamic signage system, examples of use of dynamic signage devices, a centralized management system allowing the information content presented by dynamic signage devices to be coordinated across multiple stores, and a system to design layout of a retail store. Although the embodiments described may make reference to specific products (e.g., a particular model of mobile phone) or categories of products (e.g., mobile phones or electronic devices), it is to be understood that the dynamic signage systems described herein can be used in connection with any type of product, not limited to electronics. Additionally, the present description makes reference to various people using terms such as “customer,” “employee,” etc. It is to be understood that these terms are not limiting; for example, a customer can be anyone who interacts with a dynamic signage device to obtain information, and an employee can be anyone who works at the store or other environment where a dynamic signage device is deployed (regardless of actual job title or status as an employee, contractor, partner, owner, volunteer, etc.). Further, while systems are described with reference to retail stores, the invention is not limited to this context; dynamic signage can be used in any environment where information about products, items, commodities, and/or services is displayed, including vehicle dealerships, trade shows, kiosks, fairs, traveling exhibits, educational institutions, grocery stores, restaurants, museums, or the like.

### Dynamic Signage System

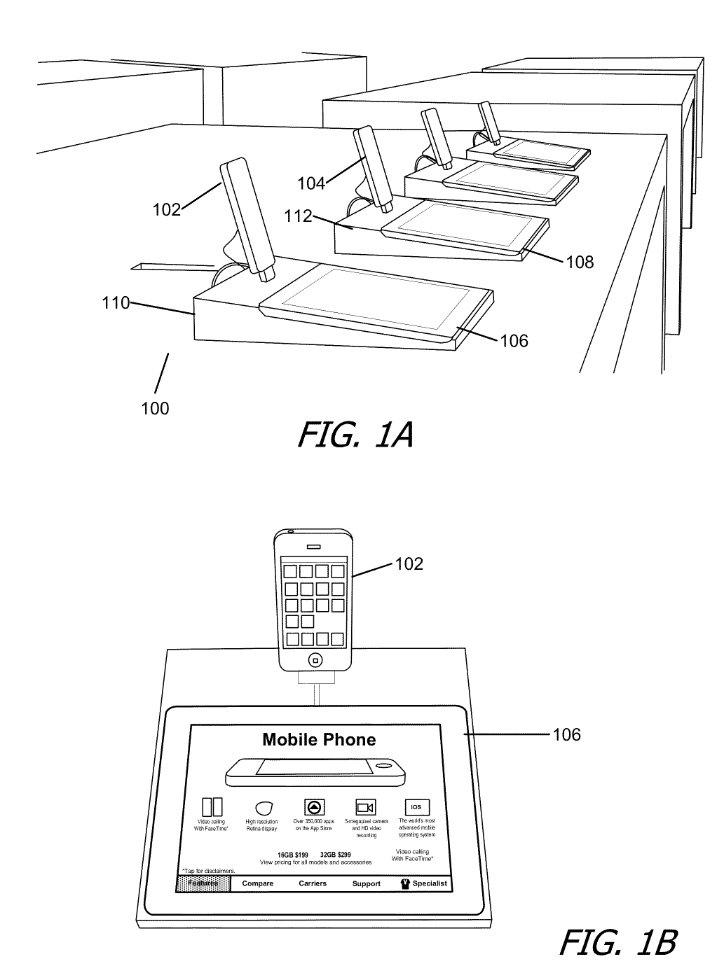

FIGS. 1A-1B illustrates a dynamic signage system in a retail store according to an embodiment of the present invention. Shown in FIG. 1A is a display surface 100 on which products 102, 104 (mobile phones in this example) are arranged. Products 102 and 104 in this example are demonstrators, or floor samples: a customer can interact with product 102 or 104. However, the presence of demonstrator products is not required; for example, dynamic signage systems can be deployed on or displays of in-box products, in museum exhibits where visitors are told not to touch the exhibited items, and so on. Products 102 and 104 can be identical or different products. FIG. 1B shows another view of product 102 and its associated dynamic signage device 106.

Adjacent to each product 102, 104 is a dynamic signage device 106, 108. In this example, dynamic signage devices 106 and 108 are implemented using tablet computers executing dynamic signage application programs, examples of which are described below. (In some instances, the product being sold can be a tablet computer, and a second tablet computer can be provided as a dynamic signage device providing information about the tablet computer product.) Dynamic signage devices 106, 108 can be temporarily or permanently affixed to display surface 100, e.g., by angled acrylic blocks 110, 112, which may also provide power and/or data connections to dynamic signage devices 106, 108. In this embodiment, dynamic signage devices 106, 108 remain in place on display surface 100 during use; customers do not pick them up.

In the embodiment shown, dynamic signage devices 106, 108 provide touchscreen interfaces. Various information items are displayed on the screen, and a customer can touch various areas of the screen to obtain additional information; examples are described below.

Thus, dynamic signage devices 106, 108 can provide an interactive customer experience, with the customer being able to quickly and easily access the information he/she wants. In addition, dynamic signage devices 106, 108 can be connected to a network (using wired and/or wireless connections) and can obtain updated product information via the network. Thus, the information provided to the customer can be kept current. Further, as described below, in some embodiments, updates can be coordinated to occur substantially simultaneously across a number of dynamic signage devices, so that information presented by different devices is always consistent.

It will be understood that products and associated dynamic signage devices can be arranged in any manner desired, and that a number of considerations, including clearly associating each signage device with a product, may be involved. The particular arrangement will depend on various considerations including the product being sold, the size and shape of the signage device, and the esthetic judgment of a store's designer(s). In some instances, a single dynamic signage device can be provided for multiple similar demonstrator products; the ratio of signage devices to products can be but need not be 1:1.

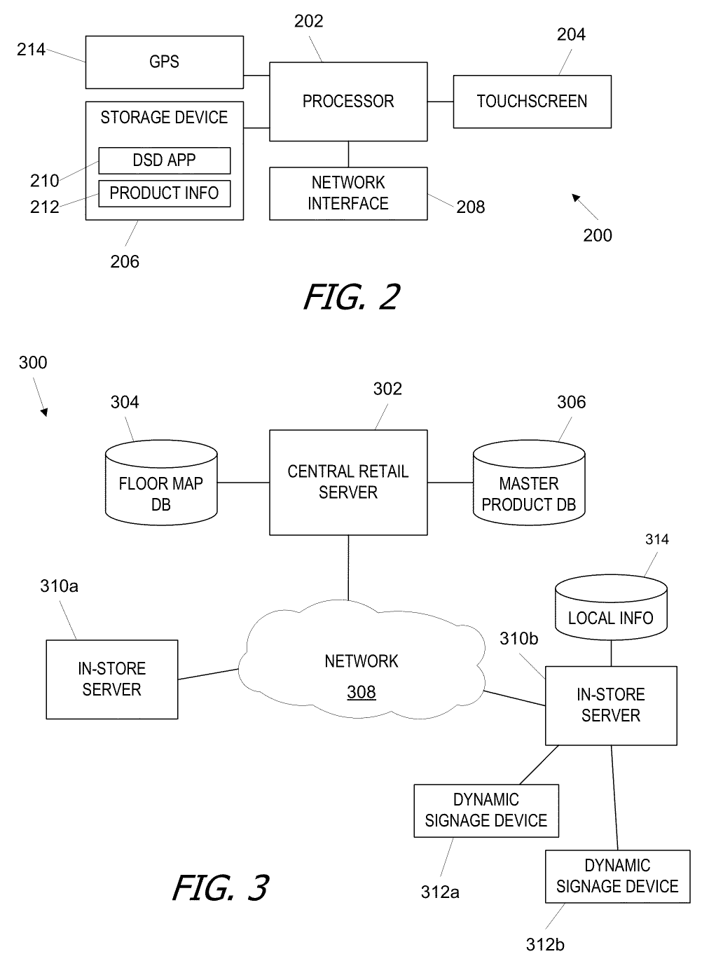

FIG. 2 is a simplified block diagram of a dynamic signage device 200 (e.g., implementing dynamic signage device 106 of FIGS. 1A-1B) according to an embodiment of the present invention. Dynamic signage device 200 includes a processor 202, a touchscreen 204, a storage device 206, a network interface 208, and a Global Positioning System (GPS) module 214.

Processor 202, which can be implemented as one or more integrated circuits (e.g., a one or more single-core or multi-core microprocessors or microcontrollers, examples of which are known in the art), can control the operation of dynamic signage device 200. In various embodiments, processor 202 can execute a variety of programs in response to program code and can maintain multiple concurrently executing programs or processes. At any given time, some or all of the program code to be executed can be resident in processor 202 and/or in storage media such as storage device 206. Through suitable programming, processor 202 can provide various functionality for dynamic signage device 200; examples are described below.

Touchscreen 204 can include a display device (e.g., an LCD-based display screen) with a transparent overlay that detects physical contact and generates electrical signals in response to such contact. The overlay can be segmented to allow determination of a specific area of the screen that was contacted. Conventional capacitive or resistive touchscreen technologies can be used. In some embodiments, other user interfaces capable of receiving input from a user and presenting outputs to a user can be provided in addition to or instead of touchscreen 204.

Storage device 206 can be implemented, e.g., using disk, flash memory, or any other non-volatile storage medium or combination of media. In some embodiments, storage device 206 can store programs, including operating-system and application programs that can be executed by processor 202, as well as data associated with the programs and/or other data. In the embodiment shown, storage device 206 stores a dynamic signage device (DSD) application program 210 and associated product information 212. DSD application program 210 can include code that, when executed by processor 202, causes dynamic signage device 200 to update and product information 212 and present items of product information 212; examples of such operations are described below.

Network interface 208 can provide data communication capability for dynamic signage device 200. In some embodiments network interface 208 can include radio frequency (RF) transceiver components for accessing wireless voice and/or data networks, such as Wi-Fi networks (IEEE 802.11 family standards), Bluetooth networks; cellular data networks (e.g., EDGE, 3G, 4G, or the like); or any combination thereof. In some embodiments network interface 218 can provide wired network connectivity (e.g., Ethernet) in addition to or instead of a wireless interface. Network interface 208 can be implemented using a combination of hardware (e.g., antennas, modulators/demodulators, encoders/decoders, and other analog and/or digital signal processing circuits) and software components. As described below, in some embodiments, network interface 208 allows dynamic signage device 200 to communicate with a local (e.g., in-store) network and/or a larger network encompassing multiple stores connected via Internet or the like. In some embodiments, larger inter-store networks can be implemented, e.g., using Virtual Private Networks (VPN) or other technology that supports secure communication over the Internet.

GPS module 214 can be configured to receive signals from Global Positioning System satellites orbiting Earth and to determine a location (e.g., latitude and longitude) based on signals received from the satellites. Conventional techniques can be used. In some embodiments, GPS module 214 can be used in determining the location and/or associated products for dynamic signage device 200.

It will be appreciated that dynamic signage device 200 is illustrative and that variations and modifications are possible. In some embodiments, dynamic signage device 200 can be implemented by installing appropriate software on a consumer electronic device such as a tablet computer. In other embodiments, dynamic signage device 200 can be a purpose-built device.

It will be appreciated that the system configurations and components described herein are illustrative and that variations and modifications are possible. For example, some embodiments need not include GPS module 214. Further, while dynamic signage device 200 is described with reference to particular blocks, it is to be understood that these blocks are defined for convenience of description and are not intended to imply a particular physical arrangement of component parts. Further, the blocks need not correspond to physically distinct components.

Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Dynamic signage device 200 can communicate with other devices via a network to obtain and update product information. FIG. 3 is a simplified block diagram of a retail network 300 according to an embodiment of the present invention. Retail network 300 can be used to coordinate information provided to different dynamic signage devices with a store, as well as to dynamic signage devices in different stores.

Retail network 300 includes a central retail server 302 that manages a floor map data store (DB) 304 and a master products data store 306. Floor map data store 304 can provide information about the current and planned future layout of every store within retail network 300, e.g., in the form of interactive floor maps as described below. Master product data store 306 can provide information about every product sold by stores in retail network 300. The information can include any type of information about the product. Examples include physical information (e.g., dimensions, color, and general appearance of the product); feature data (e.g., storage capacity, processor speed, network connectivity); marketing information (e.g., product brand name, current price, sale price); information about related products (e.g., accessories, other products in the same product line) and the like. The information can also include images of the product, screenshots from the product in use, video clips of the product being used, audio clips explaining product features, and so on. In some embodiments, master product data store 306 can be organized hierarchically; examples are described below.

Central retail server 302 can communicate via a network 308 (e.g., the Internet) with any number of in-store servers, including servers 310a, 310b, which can be located in different stores in retail network 300. (Two in-store servers are shown, but it is to be understood that there can be any number; in some embodiments, there can be one in-store server per store.) As shown for server 310b, an in-store server can communicate with one or more dynamic signage devices 312a, 312b located within that store. (Again, while two devices are shown, a store may have any number of such devices.) Also as shown for server 310b, an in-store server can also maintain a local information store 314, which can include store-specific (“local”) information. Examples of store-specific information can include current inventory levels of various products, information about which employees are currently on duty, schedules of upcoming classes or other events offered at that store, and so on. In some embodiments, store-specific information can be managed locally or via central retail server 302, or both. For example, in-store server 310b can communicate information about current inventory levels from local information store 314 to central retail server 302, which can use this information to determine whether to ship additional products to the store associated with server 310b and/or whether to order additional products.

It will be appreciated that retail network 300 is illustrative and that variations and modifications are possible. Retail network 300 can be a regional, national, or worldwide network as desired, and can include any number of stores. In some embodiments, the network can be hierarchical, with groups of stores organized into districts, districts into regions, regions into national areas, or the like, and operations related to retail network 300 can be delegated to various levels in the hierarchy. Further, when a dynamic signage device is described as communicating with an in-store server or a central retail server, such communication can be direct or indirect. For example, central retail server 300 can communicate information intended for dynamic signage device 312b to in-store serer 310b, and in-store server 310b can communicate with dynamic signage device 312b to deliver the information. Additional intermediaries can be introduced if desired, and “communication” encompasses any path from sender to recipient. As described below, retail network 300 can facilitate coordination of dynamic signage devices across stores and in some instances within stores. However, in some embodiments, dynamic signage devices can be controlled and coordinated at the level of individual stores, and retail network 300 or indeed any multi-store network is not required.

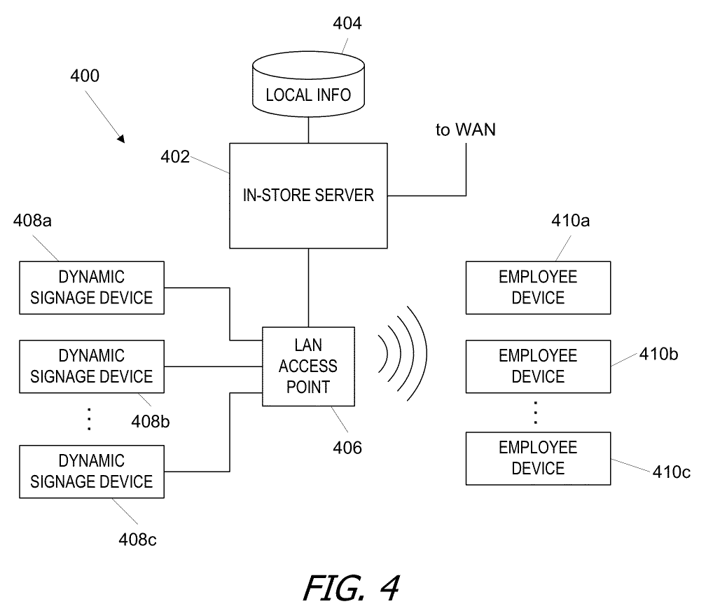

FIG. 4 illustrates an in-store network 400 according to an embodiment of the present invention. In-store network 400 can be a part of retail network 300 or a stand-alone network. Network 400 is managed by an in-store server 402, which can be connected to a wide area network (WAN), allowing server 402 to communicate with a larger retail network (e.g., retail network 300 of FIG. 3) if desired. In-store server 402 manages a local information store 404.

As described above, local information store 404 can include store-specific information. In some embodiments, local information store 404 can also include product information; if in-store network 404 is part of a larger retail network, the product information can be downloaded from that network. In other embodiments, product information can be obtained from product manufacturers, wholesalers, distributors or the like and stored in local information store 404.

In-store server 404 is connected to a local area network (LAN) access point 406, which facilitates communication with other devices in in-store network 400. Those other devices can include dynamic signage devices 408a-c and/or employee devices 410a-c. (Again, any number of each type of device can be included.) Dynamic signage devices 408a-c can provide product information and additional functionality as described herein, and connections of a given dynamic signage device 408a-c to LAN access point 406 can be wired or wireless as desired.

Employee devices 410a-c can be handheld devices carried or worn by employees of the store while on duty, and devices 410a-c can be configured with software related to the employee's job duties, including for example software for checking inventory, obtaining product information, scheduling customer-service appointments, processing payments, and so on. In some embodiments, employee devices 410a-c can receive customer assistance requests from dynamic signage devices 408a-c and can alert employees to the request; examples are described below. Employee devices 410a-c can be configured for wireless communication with access point 406, allowing employees to move freely about the store while remaining in communication with network 400. In some embodiments, wired employee devices can also be used.

It will be appreciated that the various systems and devices described herein are illustrative and that variations and modifications are possible. Dynamic signage devices can be deployed in a single store or across multiple stores as desired, and different devices within a deployment may be but need not be identical in size and/or capabilities. Devices can be connected into networks of any desired scale, and operation of the devices can be coordinated across the network. Examples of operating and coordinating dynamic signage devices will now be described.

### Initialization and Updating of Dynamic Signage Devices

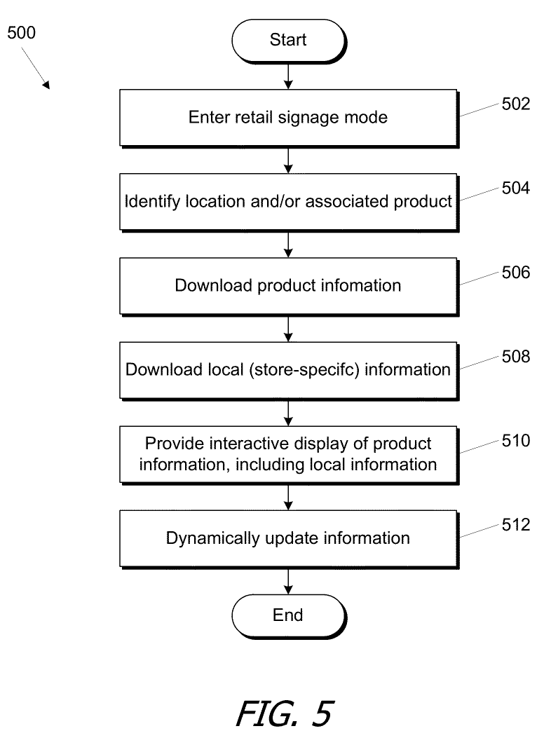

FIG. 5 is a flow diagram of a process 500 for initializing a dynamic signage device (e.g., device 106 of FIGS. 1A-1B) according to an embodiment of the present invention. Process 500 can be used to establish an association between a dynamic signage device and a product and to provide product information to the dynamic signage device.

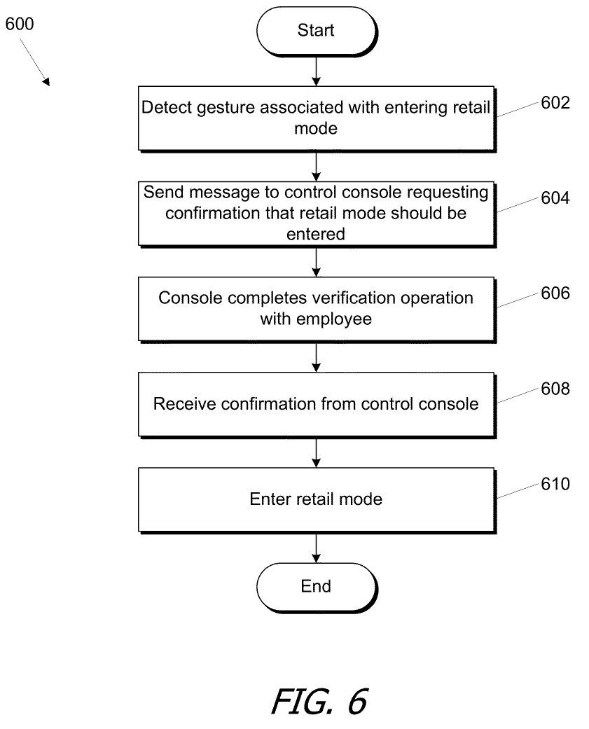

At block 502, the dynamic signage device can enter a “retail” mode. In some embodiments, entering retail mode can happen automatically at device startup. In other embodiments, entering retail mode can include a store employee launching a DSD application program. As described below with reference to FIG. 6, access control procedures can be used to prevent devices from entering the retail mode when not desired.

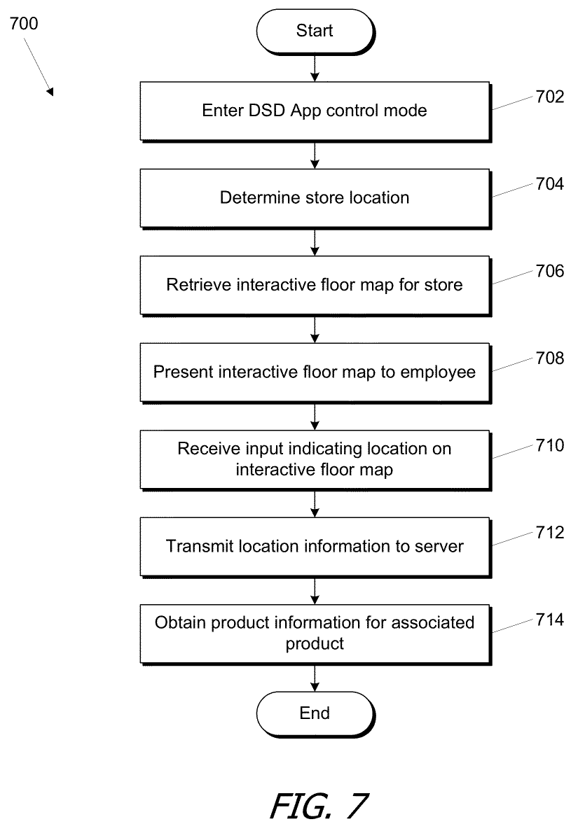

At block 504, the dynamic signage device can identify an associated product. In some embodiments, a store employee can enter a product identifier, e.g., an SKU number (Stock Keeping Unit) or other identifier uniquely associated with a specific product model. In other embodiments, product identification can be based on location of the dynamic signage device; an example is described below with reference to FIG. 7. In embodiments where product identification is based on location, the dynamic signage device can operate without ever receiving or storing a product identifier; as described below, a server (e.g., in-store server 402 of FIG. 4 and/or central retail server 302 of FIG. 3) can associate the location of the dynamic storage device with a product identifier (e.g., based on an interactive floor map) and use that association to provide product-specific information to the dynamic signage device based on its location.

At block 506, the dynamic signage device can download and store product information for the associated product. Information can be downloaded, for example, from master product data store 306 (FIG. 3) and/or local information store 314. In some embodiments, the information can include ready-to-display images (e.g., full screen images) and instructions pertaining to when to display each image (e.g., instructions for interpreting user input and selecting a next image based on user input). In addition or alternatively, the information can include information elements (e.g., a price, a memory size, or the like) that the dynamic signage device can incorporate into an image template already stored by the dynamic signage device.

At block 508, the dynamic signage device can download and store local (i.e., store-specific) information that might or might not be associated with the product. Local information can be downloaded, for example, from local information store 314. This may include information such as schedules of classes or product demonstrations offered at a particular store, availability of appointments to speak with sales or service consultants, location-based special offers, or the like.

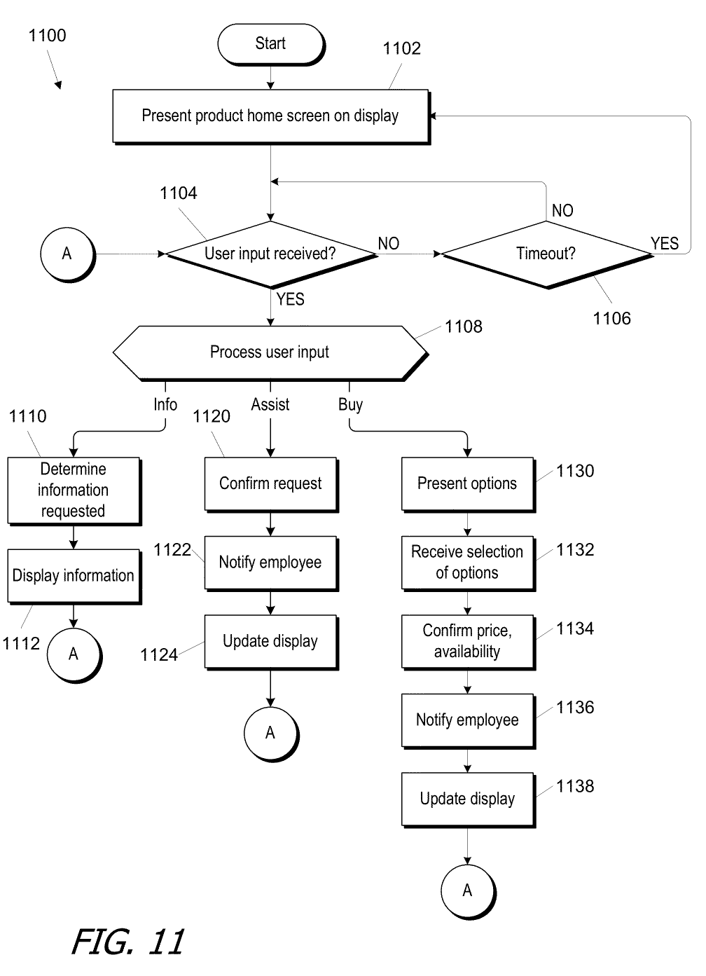

At block 510, the dynamic signage device can provide an interactive display of product-related information. The interactive display can include information obtained at blocks 506 and/or 508. At this point a customer can interact with the dynamic signage device to obtain product information or the like. Examples of interactive display are described below with reference to FIG. 11.

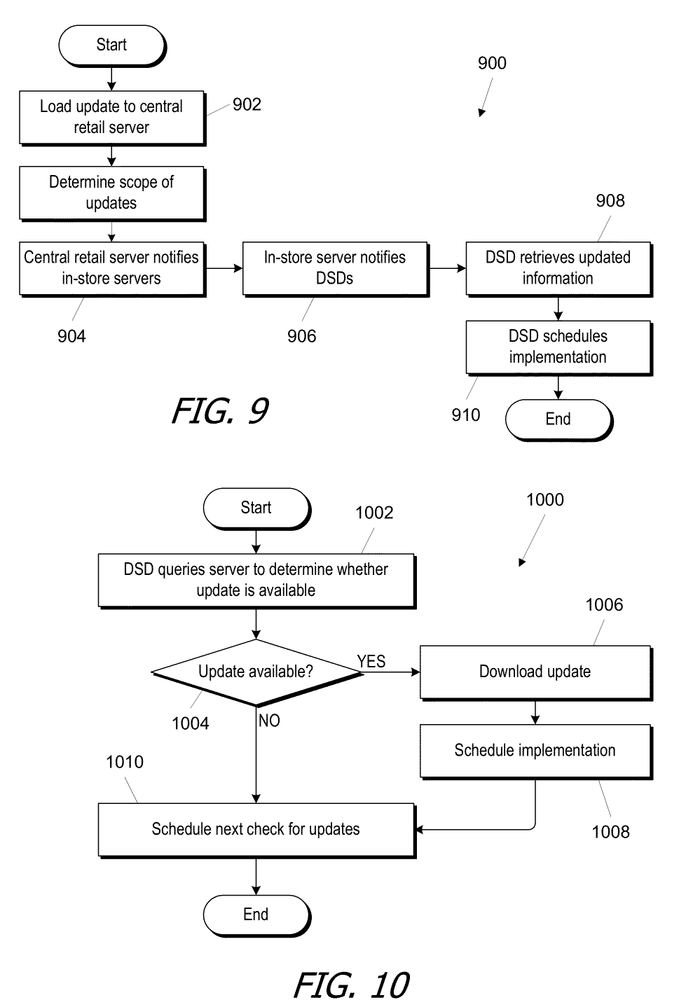

At block 512, the dynamic signage device can dynamically update product information. In some embodiments, updates can be pushed out to dynamic signage devices, e.g., by central retail server 302 or in-store server 310b of FIG. 3. In other embodiments, the dynamic signage device can periodically (e.g., every 15 minutes, every 30 minutes, hourly or daily) poll central retail server 302 and/or in-store server 310b to determine whether an update is available; if so, the dynamic signage device can downloaded the updated information. Examples of updating are described below with reference to FIGS. 9 and 10.

Process 500 can continue indefinitely, with dynamic signage device providing information to users and dynamically updating the information. In some embodiments, process 500 ends when the dynamic signage device is powered down or when an employee terminates the dynamic signage application program.

In some embodiments, it may be desirable to restrict access to certain functionality of a dynamic signage device to store employees. For example, it may be desired that customers not be able to launch or terminate the dynamic signage application or change the association between a dynamic signage device and a product. Accordingly, some embodiments incorporate security measures to prevent unauthorized operations by customers.

FIG. 6 is a flow diagram of a process 600 for entering retail mode according to an embodiment of the present invention that incorporates security measures. Process 600 can be performed, e.g., at block 502 of process 500 of FIG. 5.

At block 602, the dynamic signage device detects, via its touchscreen interface, a specific gesture or sequence of gestures associated with entering the retail mode. For example, the sequence may be a tap with one finger followed by a tap with two fingers then a tap with three fingers; any other gesture or sequence of gestures can also be used. In some embodiments, the gestures can include button presses if the dynamic signage device has physical buttons and/or operation of any other user input controls of the dynamic signage device. In some embodiments, a gesture is chosen that is not likely to be used during normal customer operation of the dynamic signage device.

In some embodiments, the gesture itself is sufficient to enter retail mode. In other embodiments, further verification can be required. Accordingly, at block 604, the dynamic signage device can send a message to a control console requesting confirmation that it should enter retail mode. The control console can be located remotely from the dynamic signage device. For example, the control console can be provided in a user interface connected to in-store server 402 of FIG. 4, or in one or more of employee devices 410a-c. At block 606, an employee can communicate with the control console to confirm that the retail mode should be entered; in one embodiment, the control console can prompt the employee to enter a passcode, and the employee can enter the passcode into the console in response to the prompt. In some embodiments, the employee interaction with the control console can be done in a location where there is low risk that a customer would be able to obtain the passcode.

At block 608, the dynamic signage device can receive confirmation of the passcode from the console. In the event of an error (including failure of an employee to confirm), the console can notify the dynamic signage device of the error, and process 600 can exit before block 610. At block 610, assuming the request was confirmed, the dynamic signage device can enter the retail mode.

It will be appreciated that process 600 is illustrative and that variations and modifications are possible. Steps described as sequential may be executed in parallel, order of steps may be varied, and steps may be modified, combined, added or omitted. In some embodiments, rather than communicating with a separate control console, the dynamic signage device can display a confirmation screen, and the employee can enter a passcode or other confirmation at the confirmation screen.

In some embodiments, a process similar to process 600 can be used while the dynamic signage device is in retail mode. For example, if an employee wants to switch the dynamic signage device out of retail mode (e.g., to look up information for a customer or place an order or the like), the employee can make the appropriate gesture and confirm the action by entering a passcode on the dynamic signage device or a console displayed on her employee device. As another example, an employee may want to update settings for the dynamic signage device (e.g., change its location or product association, download an update to the signage device software, or the like); again, the gesture-and-confirm sequence can be used to prevent unauthorized access to these features.

As described above with reference to FIG. 5, the dynamic signage device can be associated with a particular product and can display information about the product. FIG. 7 is a flow diagram of a process 700 for associating a dynamic signage device with a product based on the location of the dynamic signage device according to an embodiment of the present invention. Process 700 can be used to implement blocks 504 and 506 of process 500 (FIG. 5) in embodiments where the dynamic signage device is part of a retail network such as retail network 300 of FIG. 3.

At block 702, the dynamic signage device enters a DSD application control mode, e.g., in response to a gesture-and-passcode sequence as described above with reference to FIG. 6. The control mode allows an employee to change various settings of the dynamic signage device, including product associations and/or location information.

At block 704, the dynamic signage device identifies its store (i.e., which store it is located in). For example, as described above (FIG. 2), a dynamic signage device can be equipped with a GPS receiver and can determine its location coordinates (latitude and longitude). In embodiments where the dynamic signage device has access to a list of location coordinates of the stores in retail network 300, the device can match its coordinates to one of the stores.

Assuming the stores are located far enough apart that their coordinates can be reliably distinguished using GPS, the device can determine that it is located in the store whose coordinates are the nearest match to the device's coordinates. Alternatively, the dynamic signage device can send its GPS coordinates to a server, which can identify the store. In still other embodiments, the dynamic signage device can communicate with an in-store server that is specific to a particular store, and the store can be identified by virtue of the in-store server having information as to its own location.

Next, the dynamic signage device can determine its location within the store. In some embodiments, at block 706, the device can retrieve, e.g., via retail network 300, an interactive floor map of the store identified at block 704. In other embodiments, an in-store server may have the floor map for its associated store and can simply provide the map to the dynamic signage device. At block 708, the dynamic signage device can present the interactive floor map to an employee, e.g., using its touchscreen display. The interactive floor map in some embodiments indicates where, within the store, each product display is located and identifies the products displayed at each such location.

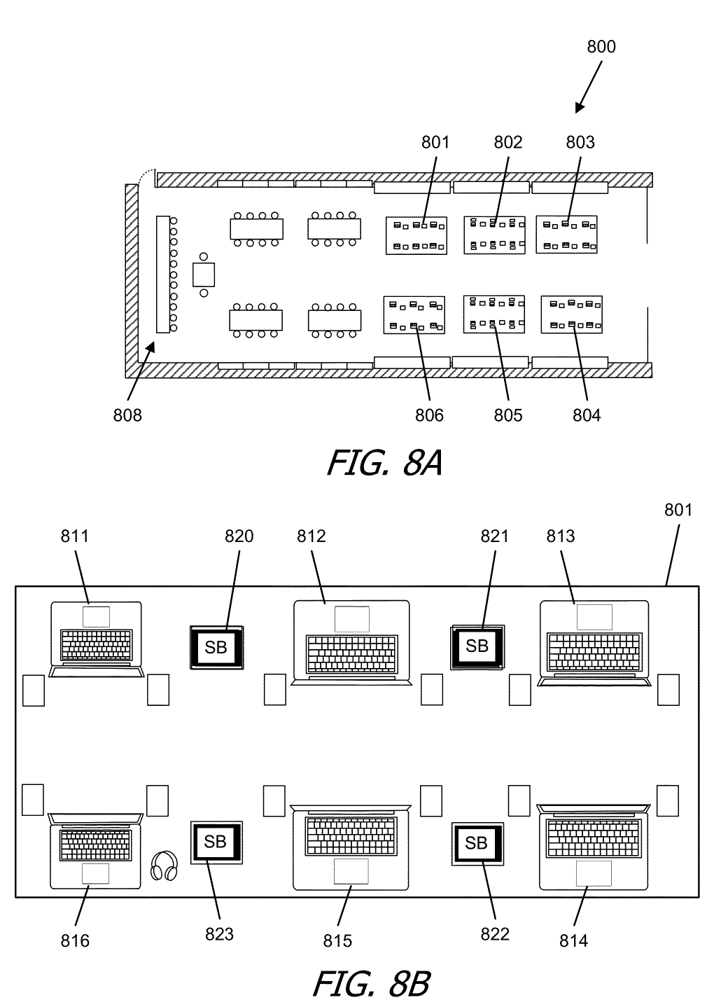

An example of an interactive floor map (which may be referred to as a “planogram”) is illustrated in FIGS. 8A-8B. FIG. 8A shows a map 800 for a particular store. The map shows the locations of display fixtures 801-806, which are surfaces on which various products have been arranged. The map can also show other portions of the store, such as a technical support area 808.

FIG. 8B shows a detail of fixture 801 from map 800. As best seen in FIG. 8B, map 800 can show the specific products 811-816 arranged on the display fixture and the positioning of dynamic signage devices 820-823.

Referring again to FIG. 7, at block 710, the employee can indicate the location of the dynamic signage device on interactive floor map 800. For example, in some embodiments, map 800 of FIG. 8A is initially presented. The employee can zoom in or tap on the appropriate fixture to obtain a close-up view as shown in FIG. 8B. The employee can then tap on the location of the dynamic signage device (e.g., location 820).

At block 712, the dynamic signage device can transmit to a server (e.g., in-store server 402 or central retail server 404) location information based on the input received at block 710.

The server can use this information to determine which product is currently associated with the dynamic signage device. For example, in some embodiments, interactive floor map 800 includes data (e.g., an SKU number) identifying each product 811-816 associated with a given fixture and associating each of the dynamic signage locations 820-823 with one of products 811-816; for instance, signage location 820 can be associated with product 811. Based on this, if the employee indicates that the dynamic signage device is at location 820, the server can determine that the associated product is product 811. In an alternative embodiment, the dynamic signage device can interpret the interactive floor map and determine the SKU number or other identifier for the associated product and send this identifier to the server.

At block 714, the dynamic signage device can receive product information for the associated product. For example, if the associated product is product 811, an in-store server and/or central retail server can use the SKU of product 811 to retrieve product information from a products data store and provide that information to the dynamic signage device.

It will be appreciated that process 700 is illustrative and that variations and modifications are possible. Steps described as sequential may be executed in parallel, order of steps may be varied, and steps may be modified, combined, added or omitted. Location information, such as GPS coordinates and/or identified locations on a map, can be interpreted by the dynamic signage device or communicated to a server capable of interpreting the information. In some embodiments, the server (or servers) interacts with the dynamic signage device based on the location information, and the dynamic signage device need not obtain a product identifier at any time; the server can provide appropriate product information based on the location of the dynamic signage devices and information (e.g., a floor map) available to the server that associates the location with a product. In some alternative embodiments, the employee can enter an SKU number or other product identifier directly into the dynamic signage device, rather than relying on location information.

In another embodiment, determination of the device location within a store can be automated. For example, a store can be equipped with a network of low-power wireless sensors (e.g., Bluetooth LE sensors) positioned at known locations; in some embodiments, a sensor can be placed under each location where a dynamic signage device is to be positioned. If the dynamic signage device is capable of detecting the sensor signals, the device can determine its location within the store relative to the sensors, e.g., by comparing the strength of signals received from different sensors. The device can communicate its sensor-relative location to the in-store server (or an off-site server), which can use that information in combination with the known sensor locations to determine the device's location on map 800. The product information associated with that location can then be determined from map 800.

Once the dynamic signage device has received the product information, it can begin displaying that information for customers. As noted above, however, it may be desirable to update the product information from time to time. In various embodiments, this can be done by pushing or pulling updates from a server (e.g., central retail server 302 or in-store server 310b). In addition, updates can be coordinated across multiple dynamic signage devices, e.g., by providing an effective time for each update. The device can download the update in advance of the effective time and begin displaying the updated information when the effective time arrives.

In another scenario, in some embodiments, products may be rearranged within a store, without necessarily moving the dynamic signage devices. As described above, a server can maintain location information for the dynamic signage devices and can associate the devices with products based on locations of the devices and a map indicating locations of products. In connection with rearrangement of products, the server can be given an updated map reflecting the new arrangement and can provide information for a different product (or updated model of the same product) to the dynamic signage devices based on the updated map. Alternatively, when products are rearranged, the dynamic signage device can obtain a new product identifier (from the server or an employee) and obtain information associated with the new identifier.

Thus, updating of product information can include updating information about the product associated with the dynamic signage device and/or changing which product is associated with the device and consequently updating the dynamic signage device to provide information pertaining to the new product.

FIG. 9 is a flow diagram of a process 900 for pushing an update out to a dynamic signage device according to an embodiment of the present invention. Process 900 can be implemented, e.g., in retail network 300 of FIG. 3. At block 902, updated information is loaded to central retail server 302. In some embodiments, the updated information is associated with a particular product (or group of products). The updated information can also include an “effective time,” i.e., an indication of the date and time at which all dynamic signage devices associated with the product are to begin displaying the updated information. Updated information can be loaded by an authorized user of central retail server 302.

At block 903, the central retail server 302 can determine the nature of the updates. As noted above, the updates can include new information (e.g., price changes) for an existing product and/or changes in the associations between products and locations.

At block 904, central retail server 302 notifies in-store servers 310a-b of the update. In some embodiments, the notification may include the updated information. In other embodiments, the notification may indicate that the update is available, identify the affected product (or group of products), and indicate the effective time. If the update only affects certain stores, central retail server 302 can selectively notify in-store servers for the affected stores.

At block 906, an in-store server 310b can notify dynamic signage devices 312a and/or 312b of the update. In some embodiments, the notification may include the updated information. In other embodiments, the notification may indicate that the update is available, identify the affected product (or group of products), and indicate the effective time. In some embodiments, in-store server 310b selectively identifies only those dynamic signage devices whose information needs to be updated. To identify the affected dynamic signage devices, server 310b can make use of an interactive floor map, and in some embodiments, the update can include a change to the floor map in addition to or instead of changes to the information about particular products; a dynamic signage device can be notified of an update if its associated product is being changed or if the information about an associated product is being changed. In some embodiments, the notification may include the updated information.

At block 908, a dynamic signage device 312a that receives a notification can retrieve the updated information (if the information was not already included in the notification at block 906). In some embodiments, the new information does not overwrite information already stored in device 312a but is stored in a different area.

At block 910, the dynamic signage device can schedule implementation of the update such that it begins displaying the updated information when the effective time of the update arrives. This scheduling decouples receipt of an update from displaying it, facilitating synchronization of updates across multiple signage devices, either within the same store or across multiple stores.

FIG. 10 is a flow diagram of a process 1000 for pulling updated information by a dynamic signage device according to an embodiment of the present invention. Process 1000 can be implemented, e.g., in a dynamic signage device 312a (or 312b) included in retail network 300 of FIG. 3. At block 1002, dynamic signage device 312a queries a server (e.g., in-store server 310b and/or central retail server 302) to determine whether an update is available. In some embodiments, the query includes the SKU number or other identifier of the product with which dynamic signage device 312a is currently associated. In other embodiments, the server maintains information associating each dynamic signage device with a product, and the query can include just an identifier of the dynamic signage device and/or a current location of the dynamic signage device (e.g., as established using process 700 of FIG. 7).

At block 1004, the dynamic signage device receives a response indicating whether updated information is available. In some embodiments, the server that receives the query determines whether updated information is available for the product with which the signage device is associated, either because the product information is being updated or because the product associated with the dynamic signage device is being changed. As in process 900, the updated information can be provided to the server at any time, e.g., by an authorized user of the server or by another server up the chain (for example, an in-store server may receive updated information from a central retail server). In some embodiments, the determination can be based on the location of the dynamic signage device and a current or new product association determined from an interactive floor map, or on any other information associating the dynamic signage device with a product.

At block 1006, if updated information is available, the dynamic signage device downloads the updated information. Similarly to process 900, the updated information can include an effective time for the update. At block 1008, the dynamic signage device can schedule implementation of the update such that it begins displaying the updated information when the effective time of the update arrives. As in process 900, this scheduling decouples receipt of an update from displaying it, which can facilitate synchronization of updates across multiple signage devices, either within the same store or across multiple stores.

At block 1010, regardless of whether an update was downloaded, the dynamic signage device can schedule its next check for updates before process 1000 ends. The device can check for updates at regular intervals, e.g., every 15 minutes, every half hour, every hour, daily, or at other desired intervals.

It will be appreciated that the update process described herein is illustrative and that variations and modifications are possible. Steps described as sequential may be executed in parallel, order of steps may be varied, and steps may be modified, combined, added or omitted. In some embodiments, updates can be pushed from a central server to the in-store servers, then pulled from in-store servers by the affected dynamic signage devices, combining aspects of processes 900 and 1000. In other embodiments, in-store servers can pull updates from a central server, then push those updates to affected dynamic signage devices. If the network contains other hierarchical levels (districts, regions, nations, etc.), updates can be distributed at any level through any combination of “push” and “pull” operations.

As noted above, updates need not (although they can) take effect immediately. Instead, updates can be scheduled to take effect at a later time. Distribution of the update can begin far enough in advance of the effective time that all affected dynamic signage devices will have time to obtain the updated information before the effective time arrives. The effective time can be defined locally, e.g., to take effect at 10 a.m. local time on June 1, or globally, e.g., to take effect at noon GMT on June 2. In the former case, stores in different time zones may display inconsistent information depending on whether the effective time has arrived; in the latter case, stores around the world can switch to updated information effectively simultaneously.

In some embodiments, effective times will be chosen to occur while a store is closed. This reduces the likelihood that different devices in the same store would briefly present inconsistent information while an update is taking effect; however, it is not required. For example, a retailer may want to provide a deep discount for a short period of time (e.g., between 2 p.m. and 4 p.m. on a given date, an item's price is reduced by 50%). In this case, the updates can be scheduled such that all dynamic signage devices in the store begin displaying the sale price at 2 p.m. and revert to the pre-sale price at 4 p.m.

### Customer Experience

As described above, a dynamic signage device can be associated with a particular product (either directly, e.g., via product identifier, or indirectly, e.g., via association of the device with a location and association at a server of the location with a product based on a floor map or the like). Once this association is established and the device obtains product information (which can be pushed or pulled), it can begin interacting with a customer to provide product information and, in some embodiments, additional services.

FIG. 11 is a flow diagram of a process 1100 that can be used for interactive presentation of product information according to an embodiment of the present invention. Process 1100 can be implemented in a dynamic signage device, e.g., device 106 of FIGS. 1A-1B.

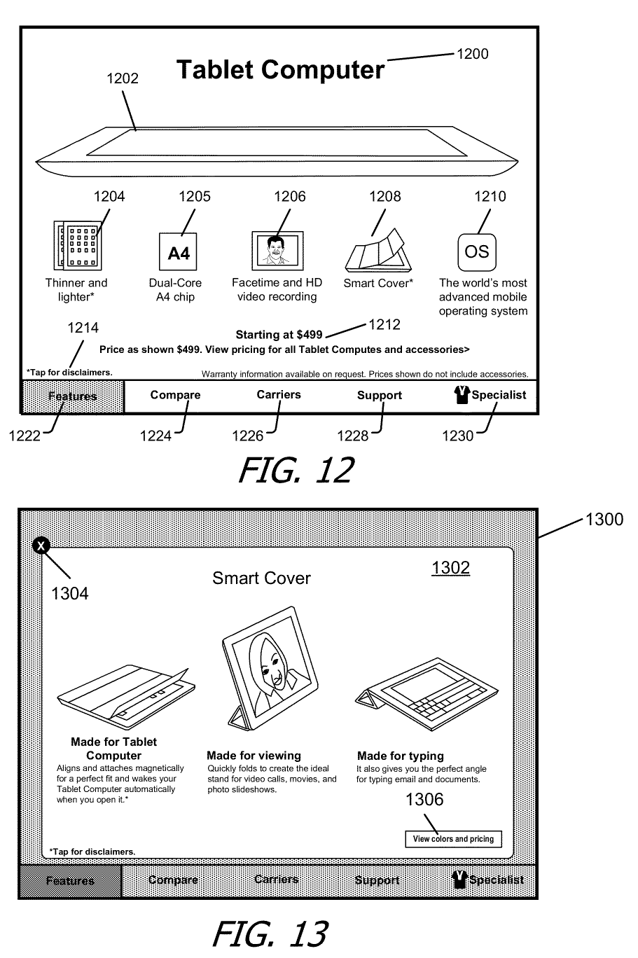

At block 1100, the dynamic signage device presents a product home screen on its display. An example of a product home screen is shown in FIG. 12. The product home screen can include the product name 1200 and one or more images 1202 of the product. The product home screen can also identify features likely to be of interest to the user (e.g., at 1204-1210). In some embodiments, a customer can tap on these features to learn more; examples are described below. The product home screen can also include pricing information 1212; in some embodiments, a customer can tap on the price area to see more details about available models and prices. Other areas 1214 allow the user to view legal information about the product (disclaimers, warranties, or the like). In this embodiment, the bottom of the home screen provides a row of buttons 1222-1230 that can also appear on other screens relating to the product. Uses of these buttons are described below.

Referring again to FIG. 11, at block 1104, process 1100 determines whether user input has been received. If not, at block 1106, process 1100 can determine whether a timeout period since the last user input has elapsed. In some embodiments, if some period of time (e.g., 5 minutes) elapses without any user input, it is assumed that the customer has moved on, and process 1100 can return to displaying the product home screen at block 1102, so that a new customer arriving at the product display will be more likely to begin with the product home screen.

If user input has been received, the input is processed at block 1108. For a touchscreen device, the user input can include tapping a particular area of the screen; block 1108 can include identifying the tapped area and determining a desired action associated with that area. In some embodiments, the possible actions include information (“info”) actions, assistance (“assist”) actions, and purchasing (“buy”) actions.

Info actions can be indicated, for example, by a user tapping one of features 1204-1210 or buttons 1222-1228 on the home screen of FIG. 12. When an info action is indicated, process 1100 determines what information was requested (block 1110), e.g., by identifying the particular area tapped, displays the requested information (block 1112), and then returns (node A) to block 1104 to wait for further user input.

By way of example, while viewing the home screen of FIG. 12, a customer can tap on area 1208 to learn more about the optional cover. In response, the dynamic signage device can display screen 1300 of FIG. 13. In this example, feature information is displayed in an overlay window 1302, while the home screen appears (darkened) in the background. The customer can tap the “x” icon at 1304 to close overlay 1302 and return to the home screen or tap button 1306 to see additional information about the covers.

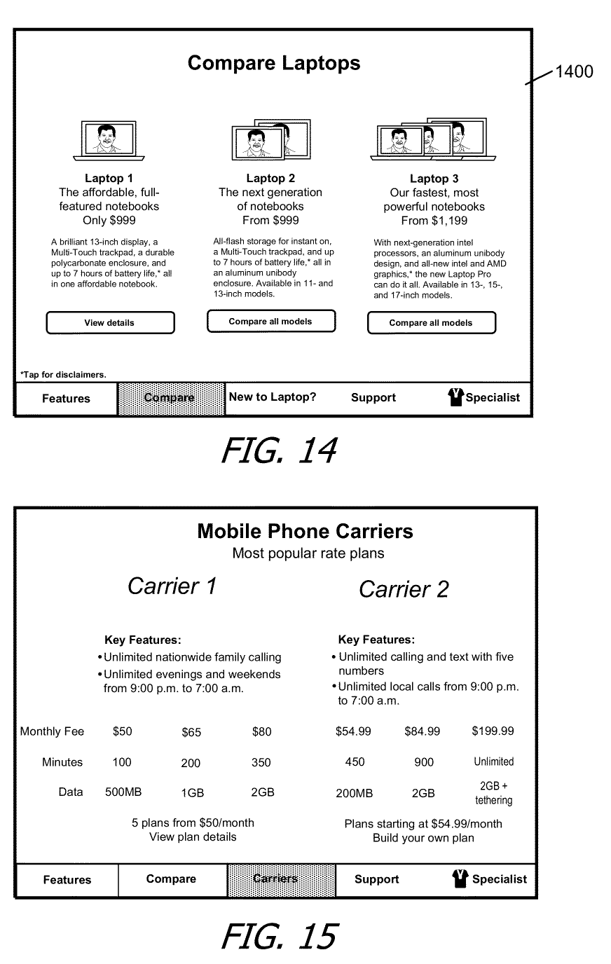

As another example, an info action can switch the customer away from the home screen to other information screens. Referring to FIG. 12, a customer can tap “Compare” button 1224 to pull up a product comparison page. By way of illustrating product comparisons, FIG. 14 illustrates a product comparison page 1400 for laptop computers. (It should be understood that this screen would typically be presented upon request from a home screen associated with a laptop computer rather than the home screen of FIG. 12, which is associated with a tablet.) Page 1400 shows various laptop lines and some basic information about the capabilities and pricing of each. The customer can tap appropriate areas on the screen to learn more about a particular line.

As still another example, from the home screen of FIG. 12, a customer can tap “Carriers” button 1226 to learn about data carriers and plans available for the associated product. FIG. 15 illustrates a carrier information screen that identifies each carrier option and provides information about the plans offered by each. (The example shown is for a mobile phone and includes voice as well as data.) In some embodiments, the customer can tap on this screen to view carrier-specific information such as coverage areas and other options.

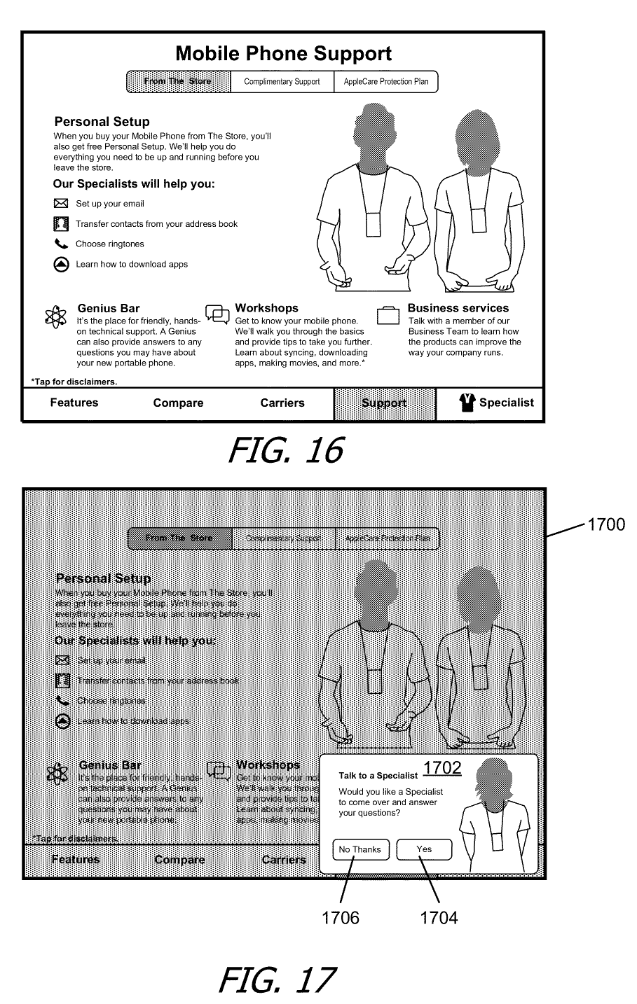

Again referring to FIG. 12, a customer can tap “Support” button 1228 to learn about the product support provided by the retailer or manufacturer. FIG. 16 illustrates a support-information page. The customer can interact with this page to obtain more details, e.g., about extended warranties, in-store support and workshops, or the like. In some embodiments, the information available includes store-specific information for the particular store the customer is in, such as a schedule of workshops or an option to schedule an appointment with a support specialist.

The foregoing examples are provided merely to illustrate information that can be provided by a dynamic signage device; it is to be understood that the information is not limited to these examples and that any type of product-related information can be presented using techniques described herein. Information can be provided using text, images, video or audio clips, synthesized speech, or any other technique or combination of techniques capable of conveying information to a person. Further, as indicated by some of the examples, the dynamic signage device is not limited to providing information about one specific product (at the

SKU-number level); information about related products can also be presented, such as other products in the same product family or accessory products that are usable with the product with which the dynamic signage device is associated.

Referring again to FIG. 11, at block 1108 the user input may be an assistance request. For example, the customer may tap “Specialist” button 1230 on the home screen of FIG. 12 or another screen. In one embodiment, at block 1120, process 110 can confirm that the customer is requesting assistance. For example, screen 1700 shown in FIG. 17 may be displayed. Here, the previous screen appears (darkened), and an overlay 1702 pops up asking whether the customer would like assistance. The customer can tap “Yes” (button 1704) to obtain assistance or “No Thanks” (button 1706) to return to the previous screen.

Referring again to FIG. 11, if the customer confirms the request at block 1120, then at block 1122, the dynamic signage device can notify an employee of the request. For example, in-store server 402 of FIG. 4 may maintain a central queue of customer-assistance requests. Dynamic signage device 408a (for example) can communicate to server 402 that a customer-assistance request was received. Server 402 can relay that information to employee devices 410a-c, e.g., via a notification that identifies the signage device that originated the request. In some embodiments, a notification can be sent to all employee devices; in other embodiments, server 402 may selectively send the notification to employee devices belonging to employees who are identified as knowledgeable about the product currently associated with signage device 408a. In some embodiments, an employee can respond to the request, e.g., by communicating to server 402 that he/she will assist the customer.

In some embodiments, employee devices 410a-c can display a list of customers requesting assistance, with each request identified by location of the customer (or the dynamic signage device) and time received; requests can be presented in order received or grouped by product or product category. Employees can select a request and indicate they are responding;

requests that have been responded to are removed from the list. This allows employees to coordinate their responses and provides some assurance that customers will be assisted in turn.

Server 402 can confirm to a requesting dynamic signage device 408a that the request has been received. In some embodiments, server 402 can provide additional information such as identification of the employee who will respond and/or an approximate wait time.

At block 1124 (FIG. 11), once an employee has been notified, the dynamic signage device can update its display, e.g., to assure the customer that help is on the way. In some embodiments, the device can identify the employee who will be assisting (e.g., by name and/or photo) and/or indicate the approximate wait time. Thereafter, process 1100 can return (node A) to block 1104 to wait for further user input; the customer can continue to interact with the signage device while waiting for an employee to arrive.

In some embodiments, a user can indicate a desire to buy a product at block 1108. For example, from a pricing screen that shows available models and prices, the user can tap a “Buy it now” button. In this case, at block 1130, process 1100 can present an “options” screen that allows the customer to select various product options such as color, display size, storage capacity, or the like. (Selection options can vary depending on product.) At block 1132, the customer can make the selections and tap an on-screen button (e.g., a “confirm”) button to indicate when she is ready to proceed. At block 1134, process 1100 confirms the price and availability of the requested product. Price, computed based on the customer's selections, can be displayed; availability can be confirmed by communicating with server 402, which can maintain inventory data for the store. The customer can be informed that the product is in stock and can be shown the price for final confirmation.

At block 1136, dynamic signage device can notify an employee, e.g., via server 402, that the customer wants to purchase a product; the notification can include a specific SKU number or other information identifying the product desired and can also indicate the customer's current location (i.e., near the dynamic signage device that is making the notification). This allows the employee to pick up the product (e.g., from a storage area in back of the store) before going to the customer's location. At block 1138, process 1100 can update the dynamic signage display to indicate that an employee will be bringing the product; the customer can complete the purchase transaction with the employee.

Alternatively, the employee may take the product to a cash register located somewhere in the store, and the display at block 1138 may indicate to the customer where to go to complete the purchase.

It will be appreciated that process 1100 is illustrative and that variations and modifications are possible. Steps described as sequential may be executed in parallel, order of steps may be varied, and steps may be modified, combined, added or omitted. The types of interactions that can be supported are not limited to those shown and described herein, and not all interactions described need to be supported. In some embodiments, additional interactions can also be supported; for example, if a user chooses to buy a product, the dynamic signage device may be configured to enter a secure transaction mode and accept payment information (e.g., credit card information), allowing the customer to pay while waiting for the product to be delivered. The various screens shown herein are solely for purposes of illustration and are not intended to limit the type, amount, format, or organization of information that can be presented. For example, information need not be limited to static images but can also include audio clips, video clips, animations, and any other media or format suitable for communicating information to a customer.

It is to be understood that any or all of the information presented to a customer by a dynamic signage device can be updated using techniques described above or other techniques. In some embodiments, an update can take effect during a customer interaction, and the dynamic signage device can be configured to alert the customer to such updates.

### Management of Product Information

As described above, dynamic signage devices can obtain and display information about various products with which they are associated. In some embodiments, product information can be stored in master product data store 306 (FIG. 3) and distributed across stores that sell a particular product.

Any type of product information can be included. Examples include: physical dimensions of the product or product components (e.g., screen size); personalization options (e.g., color, engraving); product weight; product images; technical specifications; power consumption data; interfaces supported; software or hardware components sold together with the product; additional software or hardware components required to use the product; identifiers of accessory products that may be of interest (e.g., cases, covers, or the like); price information; and so on.

In some instances, simply storing information for each product, identified by SKU number or other unique identifier, is sufficient. However, in instances where the products being sold include groups of related products, it can be more efficient to maintain the product information in a hierarchical structure.

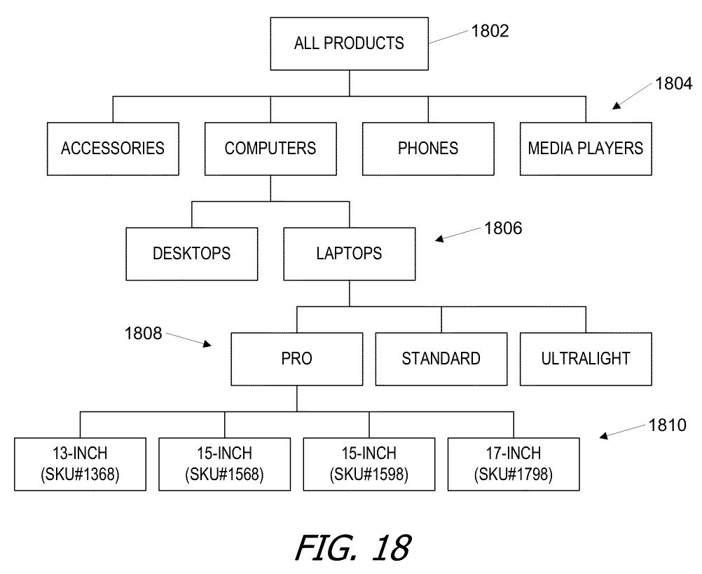

FIG. 18 illustrates a hierarchical structure 1800 for managing product information according to an embodiment of the present invention. A root node 1802 contains information pertaining to all products represented in the structure. At the next level 1804 are product types, e.g., accessories, computers, phones, media players. Any number of product types can be identified. The third level 1806 can identify product families within a given product type; for example, the “computers” product type can include “laptop” and “desktop” families. At the next level 1808 are sub-families; for example, the “laptop” family can include sub-families for “Pro,” “Standard,” and “Ultralight.” At the lowest (leaf) level 1810 are specific products, identified by SKU number; as shown, there can be several different products within a given sub-family.

In hierarchical structure 1800, attributes and values can be associated with products at any level, and lower levels inherit values from the higher (i.e., closer to the root) levels For instance, if all products have the same manufacturer, the manufacturer's name and contact information can be associated with root node 1802. As another example, the same warranty may apply to all laptops, so the warranty information can be associated with the laptop node at level 1806. In some embodiments, an inherited attribute can be overridden at a lower level. For example, if all laptop models in the standard and ultralight subfamilies have the same warranty but laptops in the pro sub-family have a different warranty, a warranty can be associated with the laptop node at level 1806 and a different warranty with the pro node at level 1808; the pro-laptop warranty will override the laptop-level warranty for each pro laptop model at level 1810.

As described above, a dynamic signage device can be associated with a specific product, e.g., a specific SKU number, corresponding to a leaf node in hierarchical structure 1800. Where product information is inherited through the hierarchy, updates to levels 1802, 1804, 1806 and 1808 can affect multiple products. Accordingly, when determining whether an update is available for a particular dynamic signage device, updates at the higher levels can be considered. Thus, for example, if a particular dynamic signage device is associated with the 13-inch pro laptop model (SKU#1368), updates to the “pro” node, the “laptops” node, the “computers” node, and the root node all would apply (unless overridden at a lower level) to that model, and an update at any of these levels can trigger an update to the dynamic signage device. In one specific example, if all laptops are on sale 10% off for some time period, all dynamic signage devices associated with all laptop models can be updated to reflect this, and the update can be coordinated across signage devices within stores and across multiple stores. Applying the update at the laptop level reduces the likelihood of a particular model not getting the update due to operator error. Further, since the updating of signage devices happens automatically as described above, store employees do not have to devote time to changing signage.

Management of Interactive Floor Maps

As described above, in some embodiments, the product association for a dynamic signage device is determined based on its location in a store, e.g., by reference to the interactive floor map of FIGS. 8A-8B. Examples of creation and management of interactive floor maps will now be described. Such maps can be used not only to associate products with dynamic signage devices as described above but also to simplify and coordinate the process of designing and implementing store layout changes, e.g., to showcase new products, promote special offers, or the like.

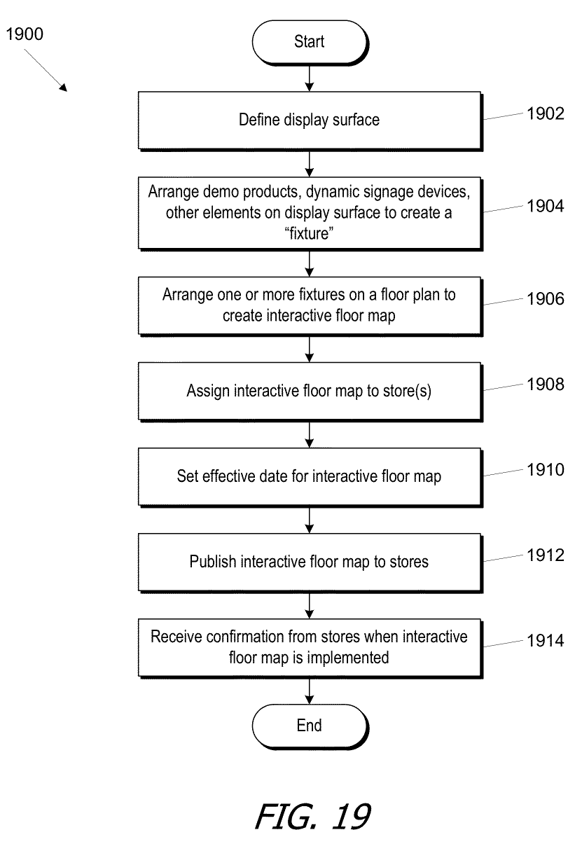

FIG. 19 is a flow diagram of a process 1900 that can be used to build an interactive floor map according to an embodiment of the present invention. Process 1900 can be implemented, e.g., in any computer system that provides a graphical user interface. In some embodiments, a corporate-level employee can use process 1900 to create interactive floor maps that provide a consistent look and feel across all of a corporation's retail outlets across a country or worldwide. In other embodiments, process 1900 can be used on a smaller scale, e.g., for a single store or small group of stores.

In process 1900, an interactive floor map such as map 800 of FIGS. 8A-8B is built up out of smaller modular units. Map 800 shows, for example, a number of fixtures 801-806, each of which has various demonstrator products 811-816 arranged thereon. Additional products such as dynamic signage devices 820-823 are also arranged on fixtures 801-806. Process 1900 allows a user to define display surfaces and arrange products and other elements thereon in order to define a fixture. Fixtures can then be arranged on a floor plan of a store to create the interactive floor map.

More specifically, at block 1902, a user can define a display surface. In some embodiments, defining a display surface includes specifying dimensions (e.g., height, width, and length), color, and other properties of the surface (e.g., number and location of power outlets, cable pass-throughs, etc.). In some embodiments, a library of display surfaces can be populated with various “standard” surfaces that are in widespread use throughout a company's stores, and block 1902 can include picking a surface from the library in addition to or instead of defining a new one. (Any new surfaces defined at block 1902 can also be added to the library.)

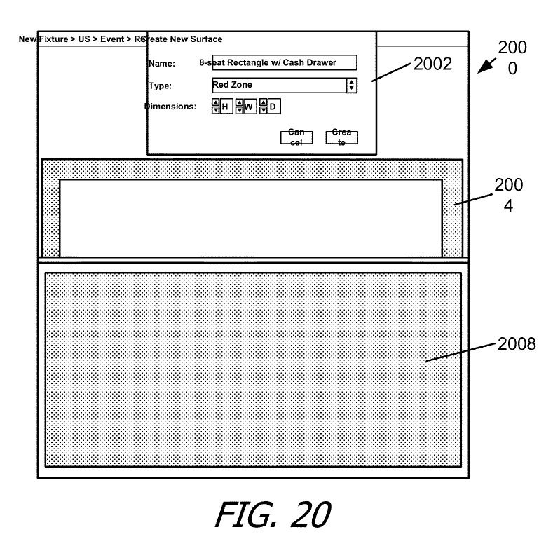

FIG. 20 illustrates a graphical user interface (GUI) 2000 for defining a display surface. Window 2002 allows the user to give the surface a name and specify its dimensions and any other attributes desired. Below window 2002 are shown a front elevation view 2004 and a top view 2008.

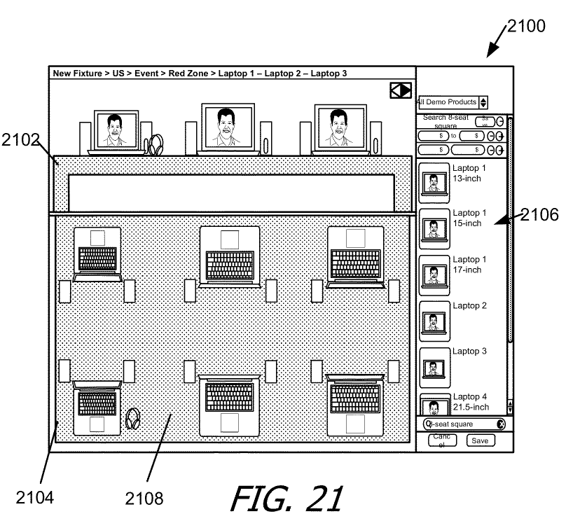

Referring again to FIG. 19, at block 1904, demonstrator products, dynamic signage devices, and other elements can be arranged on the display surface to create a “fixture.” FIG. 21 illustrates a GUI 2100 for creating a fixture. The surface selected at block 1902 is shown in front elevation view 2102 and top view 2104. At right is a list 2106 of existing products, which can be at the level of SKU number. Each product can be a draggable icon that can be “dropped” onto the display surface at a desired location. In some embodiments, the icon is associated with product dimensions and images so that realistic representations of the product in various views can be rendered as shown in FIG. 21. Further, each product instance included in the fixture can be associated with the product's SKU number, and that association can be maintained throughout creation and distribution of interactive floor maps, thereby allowing a server to determine the product associated with a dynamic signage device based on its location on a map (as described above). In addition, the SKU number can provide a convenient reference for store personnel when setting up the store in accordance with the interactive floor map, as described below.

Creation of fixtures can also include placing dynamic signage devices, e.g., device 2108, on the surface and associating each dynamic signage device with one of the products on the surface. This association can be established, e.g., by a click-and-drag operation or a pull-down menu for the signage device icon that allows the user to select which product on the surface the signage device should be associated with. In some embodiments, other elements, such as banners, static signs, posters or the like, can also be added to a fixture.

Any number of fixtures can be created at block 1904, and each fixture can be given a name and stored under that name.

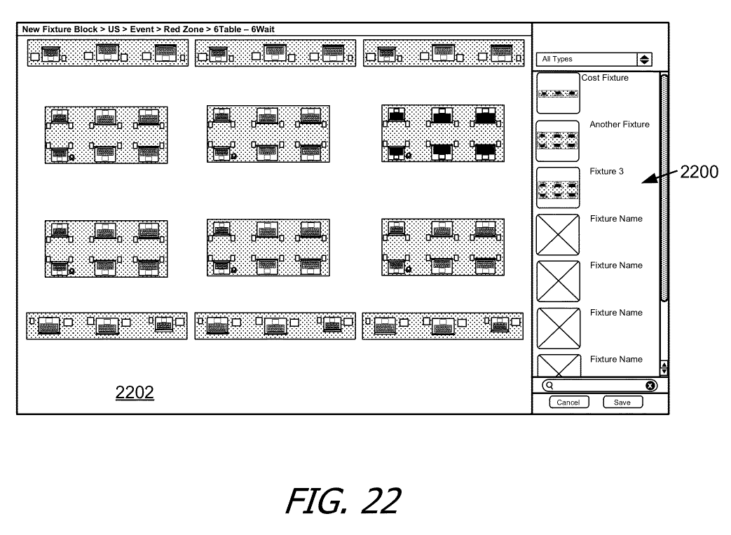

At block 1906, fixtures can be arranged on a floor plan to create an interactive floor map. In one embodiment, a library of floor plans is maintained, with each floor plan being associated with at least one store. At block 1906, a floor plan can be retrieved from the library, and fixtures defined at block 1904 can be positioned on the floor plan to create the floor map. FIG. 22 shows an example, with the fixture library in the list 2200 at the right and a floor map under construction in main window 2202. In some embodiments, fixtures can be dragged from the library onto the floor plan and positioned, rotated, mirrored, duplicated, and so on as desired.

At block 1908, the completed interactive floor map is assigned to one or more stores. In some embodiments, each store is associated with one of the floor plans in the library of floor plans, and block 1908 can include identifying the floor plan on which the interactive floor map was built, identifying the associated stores, and associating each store with the floor plan. This allows floor maps to be easily reused across stores with similar floor plans and can improve the uniformity of the customer experience across stores. In situations where a store has multiple levels, each level can have its own floor plan and associated floor map.

Blocks 1902-1908 can be repeated as desired to construct any number of floor maps for any number of stores. In some embodiments, the work flow is not necessarily linear; for example, during construction of a floor map, it may be realized that a fixture not in the library is needed; the user can switch from the floor-mapping interface to the fixture-creation interface to create the new fixture, then switch back to floor-mapping. Similarly, a new surface can be defined during the workflow.

Further, the interactive floor map can include elements other than the fixtures associated with demonstration products. Examples of such elements include freestanding signs, posters or other display items for store windows or walls, children's play areas, technical support area, workshop space, and so on.

In some embodiments, rollout of a new floor map can be coordinated across stores. For instance, at block 1910 an effective date for the new floor map can be established, and at block 1912, in advance of the effective date, the new interactive floor map can be published (distributed) to each store with instructions to implement the new floor map on the effective date. Distribution of the new floor map should occur far enough in advance of the effective date to allow for ordering and obtaining any new fixtures and/or products that may be needed to implement the map. When the effective date arrives, store personnel can then rearrange the display fixtures in the store to conform to the new floor map. (This can be done, e.g., after the store closes on the night before the effective date.) Rearrangement can include relocating some or all of the dynamic signage devices and updating the location information for each relocated device, e.g., using process 700 of FIG. 7. If a particular dynamic signage device is not moved, its location information does not need to be updated. In some embodiments, the stores can send confirmation back to a central management system at block 1914 when implementation is complete.

It will be appreciated that the floor-map creation process described herein is illustrative and that variations and modifications are possible. Steps described as sequential may be executed in parallel, order of steps may be varied, and steps may be modified, combined, added or omitted. In some embodiments, the floor maps can be used to generate reports, e.g., manifests indicating the types and numbers of products, dynamic signage devices, and other items (posters, fixtures, etc.) needed to implement the floor map. In addition, by comparing a new floor map to a currently implemented floor map for a particular store, the cost of transitioning to the new floor map can be estimated, e.g., based in part on the number of fixtures and/or products to be moved.

In some embodiments, an in-store floor map application is provided to allow store employees to view and interact with the floor maps. This application can be executed, for example, on dynamic signage devices in the store and/or other tablet or handheld computers. In one embodiment, the employees can view the current floor map and the next floor map to be implemented. The application can compare the two and highlight which fixtures will require changing. In addition, the application can allow employees to confirm when the changes to each fixture are complete; these confirmations can be transmitted to offsite management.

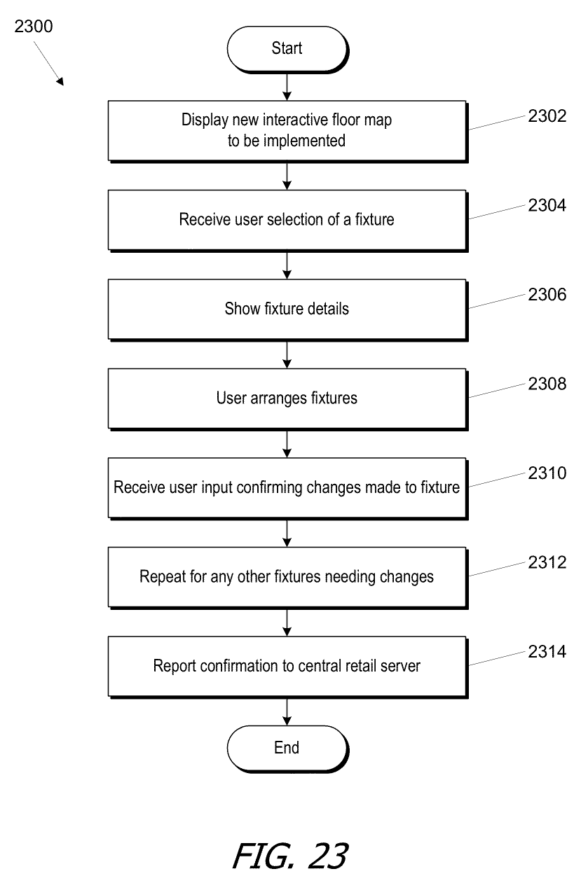

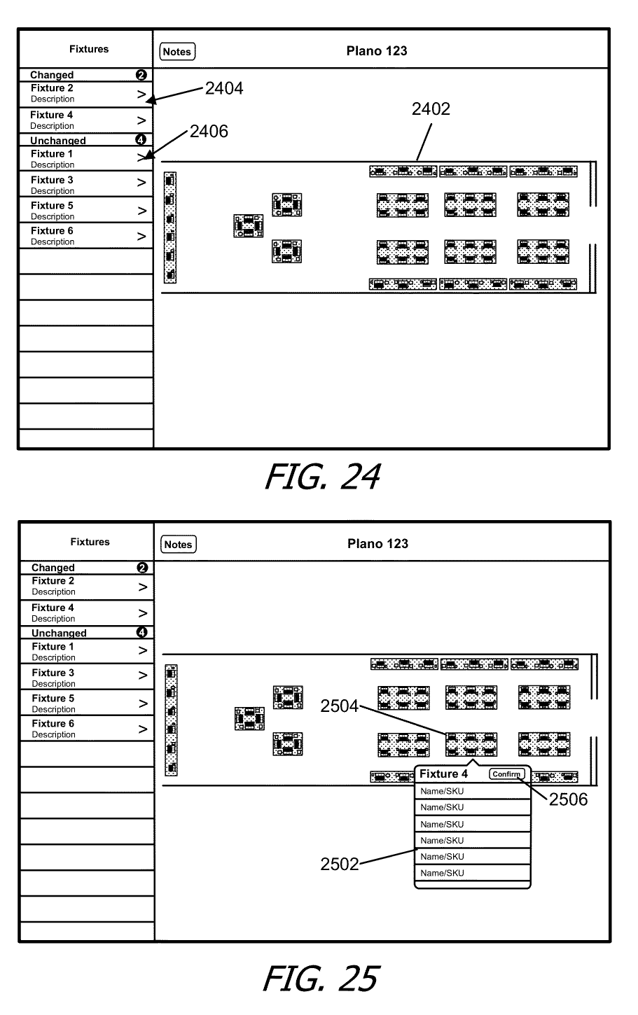

FIG. 23 is a flow diagram of a process 2300 for updating a store layout using an in-store floor map application according to an embodiment of the present invention. At block 2302, the application displays the new floor map that is to be implemented. An example is shown in FIG. 24. In addition to the floor map 2402, the display can include a list 2404 of fixtures that need to be changed and a list 2406 of fixtures that are not changed.

At block 2304, a user (a store employee) can select one of the fixtures, e.g., by tapping on the map or on the fixture identifier in the list. At block 2306, fixture details are displayed. For example, FIG. 25 illustrates one display of fixture details, in the form of a pop-up window 2502 visually associated with a fixture 2504. Window 2502 lists the products to be placed on fixture 2504. The list can be ordered by position, e.g., clockwise starting at top left.

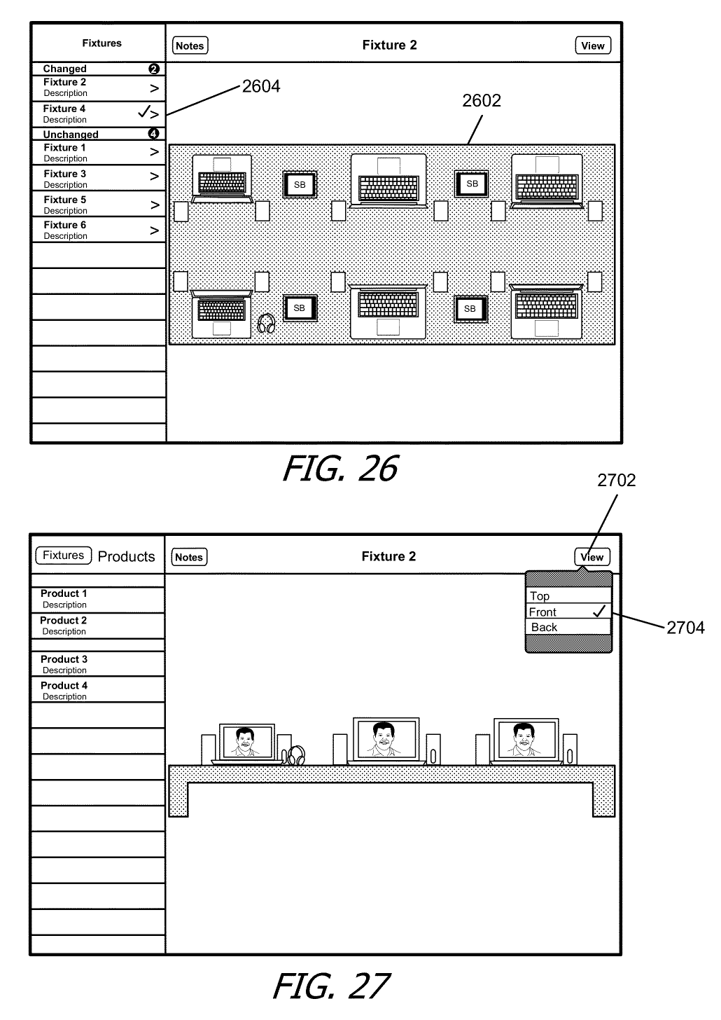

FIG. 26 illustrates another display showing fixture details. Here, the map is zoomed in to show a detailed view of a selected fixture 2602. In some embodiments, the user can switch from top view to elevation view (e.g., front view) as shown in FIG. 27; a control button 2702 and drop-down menu 2704 can be provided for view selection. In some embodiments additional views, such as rear and side views, can also be selected via button 2702 and menu 2704.

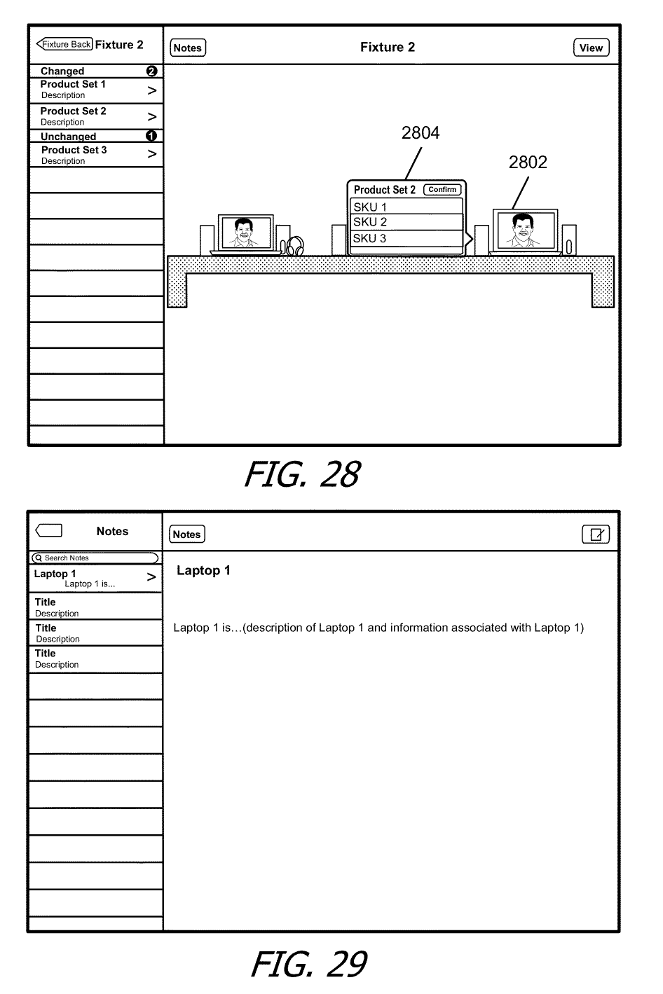

In the detailed views of FIGS. 26 and 27, a user can tap on any product or product group shown to obtain additional information. By way of example, FIG. 28 shows a pop-up window 2804 that can appear when the user taps on a product group 2802. Window 2804 can provide information about the products shown, e.g., an SKU number for each product in the group.

Referring again to FIG. 23, at block 2308, the user can arrange the fixture to conform to the floor map. At block 2310, the user can confirm to the in-store floor map application that changes have been made. For example, referring again to FIG. 25, pop-up window 2502 can include a confirmation button 2506. The user can touch button 2506 to confirm the changes. In some embodiments, once changes to a fixture are confirmed, this can be indicated visually in the fixture list. For example, in FIG. 26, a checkmark appears next to “Fixture 4” at 2604, indicating that changes to Fixture 4 have been completed.

Referring again to FIG. 23, at block 2312, the user can continue to interact with the application to make changes to other fixtures and confirm the changes on a per-fixture basis. When all fixtures have been changed, the application can report confirmation that the floor map has been implemented at block 2314.

In some embodiments, multiple instances of the in-store floor map application can be executed concurrently on different devices. The devices can communicate with each other (directly or via an in-store server) and information received from one device can be pushed out to other devices running the application. Thus, for example, if one employee marks a fixture update as complete, other employees can see the indication on their devices as well.

It is to be understood that the interactive floor map described herein can also be provided to the dynamic signage devices for purposes of identifying their location and thereby allowing the server (or the dynamic signage device itself) to determine the associated product. Accordingly, it can be useful for the interactive floor map that is distributed to each store to include the product SKU numbers, the locations of dynamic signage devices and the associations between signage devices and displayed products that were established during floor map creation (e.g., process 1900 above).

An interactive floor map application can also provide other information and functionality to store employees. For example, as shown in FIG. 29, notes can be added to a floor map. In some embodiments, a note can be associated with a particular product or fixture. The note can include any information or special instructions that the creator of the floor map chooses to provide to the store employees. Examples include identification of particular software to be installed, settings to be deployed on demonstration products, or the like. In addition, in some embodiments, employees can also add notes, which can be made visible to employees at other stores and/or to corporate management. For example, the employee can note whether a particular fixture is attracting significant crowds, how long customers are staying around a given fixture, traffic-flow problems, specific questions that are frequently asked by customers, or the like. In some embodiments, floor maps and/or product information can be altered based on feedback from employees at various stores.

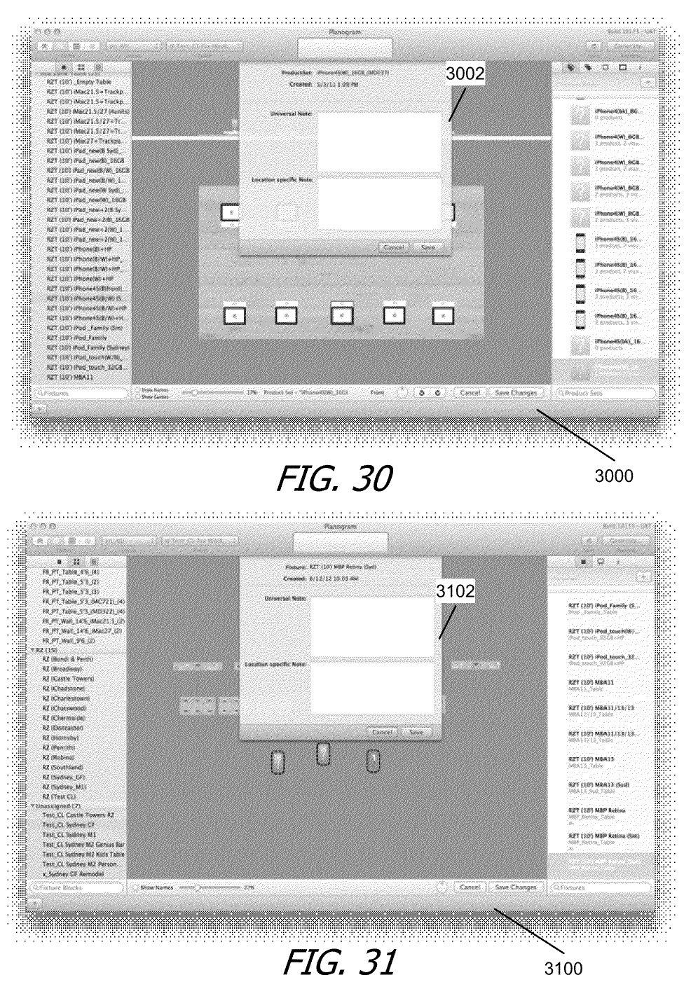

Notes can also be added during the design phase of the interactive floor map. FIG. 30 illustrates a user interface 3000 showing ability to add notes to a product set according to an embodiment of the present invention. As illustrated in FIG. 31, a designer of the interactive floor map can include notes regarding specific product sets within a window 3002. As explained above, a product set includes a product and all the related display hardware. Notes for a product set can include instructions regarding in which fixture block the product set is to be placed or any other information related to the product set that the floor map designer wants to convey.

FIG. 31 illustrates a user interface screen 3100 showing ability to add notes to a fixture, either independently or when the fixture is part of a fixture block, according to an embodiment of the present invention. As explained above, a fixture includes a product set and its associated dynamic signage system. When a user is designing a fixture to be included in a fixture block, the user can include any specific notes for that fixture in a notes window 3102. The notes can include notes related to the fixture itself such as type of fixture, criteria regarding the fixture to be considered while including the fixture in a fixture block etc. The notes can also include location specific notes that pertain to the specific location of that fixture within a fixture block or a location of the fixture in a store. For example, there may be a fixture that needs to be kept away from direct sunlight. In this instance, a location-specific note for that fixture may include instructions to the store personnel to ensure that this fixture is not exposed to direct sunlight or that such fixture is not be placed near a window in a store.

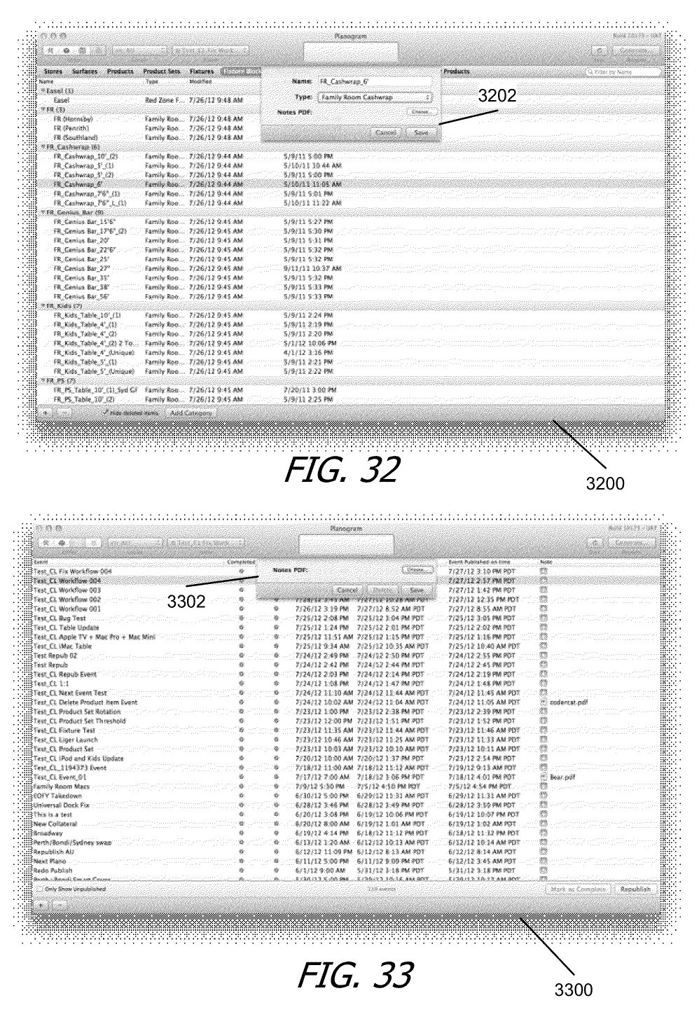

FIG. 32 illustrates a user interface 3200 for adding notes to a fixture block according to an embodiment of the present invention. As explained above, a fixture block includes one or more fixtures. A plurality of fixture blocks can be defined to include one or more fixtures. In some embodiments, all fixtures in a fixture block may be of the same type. In other words, all fixtures in a fixture block may include identical product sets. However, this is not needed. A fixture block may have fixture of different types included in it. Notes for a particular fixture block can be added in a fixture block notes window 3202. Notes for a fixture block can include information such as type of fixture block, where the fixture block is to be placed in each floor map, etc. For example, each floor map may have zones designated for certain products. These zones may be strategically located on the floor map. For example, newer products may be placed in a zone closer to the entrance of the store while older products are towards the back of the store. In this instance, the notes for a particular fixture block can indicate whether the fixture block is to be placed in a zone closer to the entrance of the store or towards the rear of the store.

FIG. 33 illustrates a user interface screen 3300 for adding notes an event according to an embodiment of the present invention. In some embodiments, an event may correspond to an entire interactive floor map for a retail store that includes a multiple fixture blocks and other information associated with the floor map. Notes associated with an event may include, e.g., information about the store associated with the interactive floor map or any other information that is peculiar for that particular interactive floor map and or store.

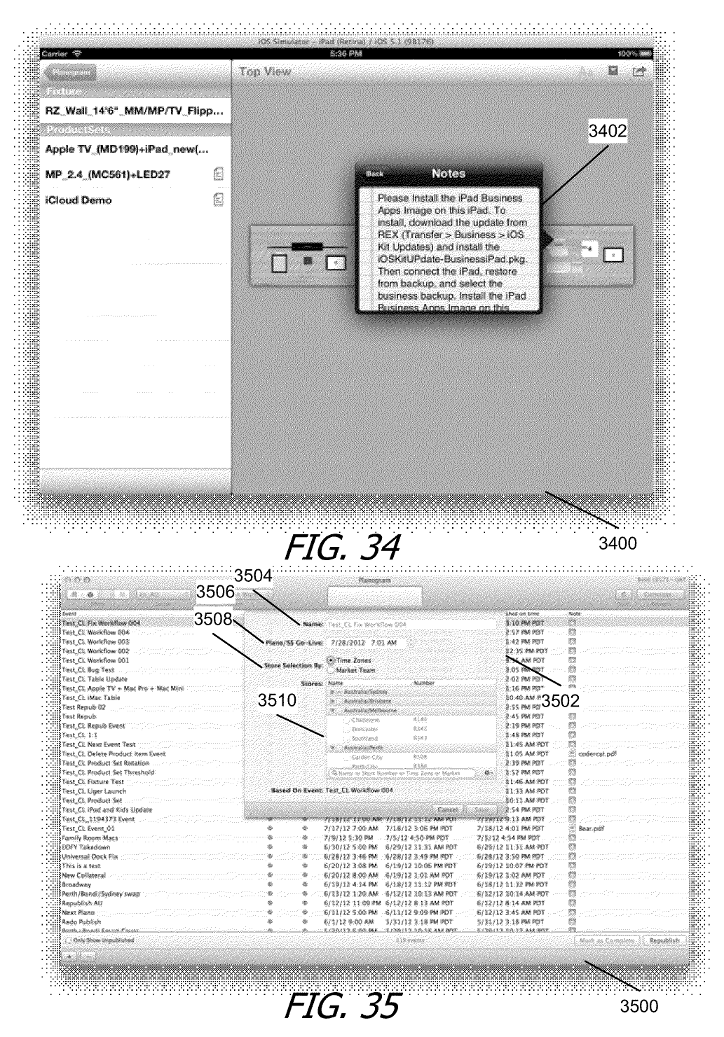

FIG. 34 illustrates a user interface screen 3400 displaying how a particular note 3402 may be displayed on a screen after its creation, according to an embodiment of the present invention. As illustrated in FIG. 34, note 3402 is associated with a particular product included in a specific fixture block and indicates instructions for installing an application on that particular product. The note may appear as a PDF file or a text file and may be downloaded separately. It is to be noted that note 3402 is merely an illustration of information that can be included in note 3402 and should not be construed to unduly limit the description and/or the invention.

The interactive floor map described above can be used to design placement of products on a floor of a retail store. Arrangement of products in a retail store may periodically need to be changed. For instance, when a new store is opened, when new products are launched, etc. the layout of the store may need to be changed. In one instance, the change in layout of the store may be designated as an event. In some instances the store layout may need to be effective at a certain date at a certain time. In this description, the action of a store layout being made active is referred to sometimes as the “go-live” event. As part of the go-live event, all the dynamic signage described above may be activated/modified to provide information about the associated products. Retail stores can be located at various locations around the world. As is well known, there are several time zones throughout the world and such local times at various locations vary with respect to each other. For example, when it is 9 AM on a Tuesday in the United States, the local time in India is 9:30 PM of the same Tuesday. Accordingly, operating hours of a retail store also vary by location. As described above, the interactive floor map includes dynamic signage devices that need to be managed in order to provide proper product related information. Due to variations in local times throughout the world, the “go-live” event is specific to a time for a location. We will now use an example to illustrate how event management can be accomplished for a new store opening. It is to be understood, that the example provided below is exemplary and the same techniques can be applied to other types of events where the “go-live” date is to be managed according to local time.

Consider that a new store is being opened in Sydney, Australia on Jan. 1, 2013. The store is scheduled to be open for business at 9 AM, local Sydney time on Jan. 1, 2013. Further consider that the central event management is being performed from Cupertino, Calif., which is in a different time zone than Sydney Australia. Once an interactive floor map has been created for the new store in Sydney, a “go-live” time and date can be associated with the store. The interactive floor map can be sent to a local server in the store prior to the actual “go-live” date and time, but will not be effective until such date and time. FIG. 35 illustrates a user interface screen 3500 that shows a window 3502 for managing the date and time for the event according to an embodiment of the present invention. User interface screen can be part of an interactive floor map application resident on, e.g., central retail server 302 of FIG. 3.

Window 3502 includes information 3504 about the interactive floor map associated with that particular store, e.g., file name of the interactive floor map. Window 3502 can further include the date and time 3506 (based on local time zone of the retail store) for the “go-live” event. Window 3502 provides the ability to choose the trigger for the event based on local time zones 3508. Based on selection of the time zone option, a selection for the particular store can be made in selection box 3510. As can be seen, the stores are displayed according to the time zones that they are located in. Once all the selections on screen 3500 are made and saved, at the selected local time in Sydney, the interactive floor map for the new store becomes active and all the dynamic signage devices can start displaying the appropriate information based on the product sets that they are associated with. Thus, regardless of where the interactive floor map for a store is designed/created or operated from, it is possible to ensure that the interactive floor map can be activated at the proper time based on the local time at the store.

It will be appreciated that the floor map creation and distribution processes described herein, as well as the particular floor maps shown, are illustrative and that variations and modifications are possible. Steps described as sequential may be executed in parallel, order of steps may be varied, and steps may be modified, combined, added or omitted. Maps can provide more or less information than the examples shown here, and maps or elements thereof can be but need not be shared across stores. Further, while maps have been described as having hierarchical structure with fixtures built up from products arranged on a surface, it is to be understood that more complex hierarchies are also possible; for example, one can define a product group (e.g., a computer plus speakers) and use the product group as a unit in fixture creation. As another example, one can also define a fixture group as a number of fixtures having a definite spatial relationship (e.g., a row of tables) and use the fixture group as a unit in constructing floor maps.

In some embodiments, the display surfaces might not move when a new floor map is implemented, and dynamic signage devices can remain attached to a display surface while different products are placed on the surface. Where the dynamic signage device is associated with a location, the change in the product associated with the location by the floor map can be detected by the server. For example, as noted above, employees can confirm when products have been moved, and the server can receive the confirmation. Accordingly, the server can initiate an update to the product information in the dynamic signage device. In other embodiments, a fixture might be movable from one location to another, and implementing a new floor map may include repositioning an entire fixture without changing the products placed thereon. In some embodiments, the server can determine that the product has not changed. In other embodiments, an employee can update the location of the dynamic signage device (e.g., using process 700 of FIG. 7) any time a device is repositioned. If the product association has not changed, the server can simply re-provide the same information.

### Further Embodiments

As described above, certain embodiments of the present invention provide dynamic signage devices and methods that can be used to associate a dynamic signage device with a product and to provide interactive presentations of information about the associated product to a user. The dynamic signage devices can be dynamically updated to reflect updated information about an associated product, and associations between products and dynamic signage devices can also be dynamically modified. The dynamic signage devices can communicate with a server (e.g., an in-store server that can be part of a larger retail network) to obtain updated product information and can switch to displaying the updated information at a scheduled effective time. In this manner, updates to multiple dynamic signage devices can be coordinated within a store and/or across multiple stores.

In some embodiments, the association between a dynamic signage device and a product can be based on the location of the dynamic signage device. Accordingly, when a dynamic signage device is initially deployed or moved within a store, an employee can interact with a map of the current store layout to indicate the device's location, and the device can transmit this location to a server (e.g., an in-store server). The server can maintain a map of locations associated with specific products and use the map to determine what product information the dynamic signage device should display. The server can provide and update the product information as appropriate. When products are rearranged, a new map can be provided to the server, and the server can use this map to update the associations of dynamic signage devices with products and consequently to change the information provided to a given device. Accordingly, the server can determine what information should be presented at a given dynamic signage device based on its location in a store.

While the invention has been described with respect to specific embodiments, one skilled in the art will recognize that numerous modifications are possible. Aspects of dynamic signage devices can be implemented with or without interactive floor maps, and interactive floor maps can be implemented in the presence or absence of dynamic signage in a particular store.

In embodiments described above, the dynamic signage device stores product information (from a master product data store and/or a local information store) and receives or retrieves updates to the information from time to time. Local storage of such information can avoid delays associated with retrieving information over a network; however, in some alternative embodiments, the dynamic signage device can retrieve product information via a network in real time while interacting with a user. Accordingly, storage of product information within the dynamic signage device is not required.

In various embodiments described above, the dynamic storage device can provide its location information or a product identifier to a server when checking for updates, notifying of customer-assistance requests, or the like. In other embodiments, the server can maintain an association between the device identifiers (e.g., a MAC address) for a dynamic storage device and a location identifier or product identifier. Consequently, the dynamic storage device can simply send its device identifier and the server can determine location and/or associated product as appropriate in a particular context. The dynamic storage device only needs to send other information (e.g., location or product identifier) if that information is being changed.

The above description makes reference to particular embodiments where the products being sold are electronic devices. This is by way of example, and it is to be understood that embodiments of the invention can be used in any type of sales environment. For example, dynamic signage devices can be used in grocery stores, department stores, gas stations, restaurants (e.g., as menus with dynamic updating to reflect availability of particular dishes, specials, or the like), trade show displays, and any other environment in which products or items of interest are presented to customers. A “product” can include any item, commodity, or service with which a dynamic signage device can be associated.

Embodiments of the present invention can be realized using any combination of dedicated components and/or programmable processors and/or other programmable devices. The various processes described herein can be implemented on the same processor or different processors in any combination. Accordingly, where components are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter-process communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded on various computer readable storage media; suitable media include magnetic disk or tape, optical storage media such as compact disk (CD) or DVD (digital versatile disk), flash memory, and the like. Computer readable media encoded with the program code may be packaged with a compatible electronic device, or the program code may be provided separately from electronic devices (e.g., via Internet download).

Thus, although the invention has been described with respect to specific embodiments, it will be appreciated that the invention is intended to cover all modifications and equivalents within the scope of the following claims.

What is claimed is:

1. A method for generating an interactive floor map for a retail store, the method comprising:
receiving, by a central server, floor information about a retail store floor, the floor information including dimensions and orientation of the retail store floor;
receiving, by the central server, information about a product from a product data store;
receiving, by the central server, information about a dynamic signage device to be associated with the product;
generating, by the central server, a fixture including a representation of the product and a representation of the dynamic signage device;
organizing, by the central server, a plurality of fixtures into a fixture block;
receiving, by the central server, instructions to arrange a plurality of fixture blocks based on the floor information of the retail store floor; and
generating, by the central server, an interactive floor map for the retail store floor, the interactive floor map including the floor information and the plurality of fixture blocks.

2. The method of claim 1 wherein each fixture block includes representations of a plurality of fixtures arranged in a particular orientation.

3. The method of claim 1 wherein each fixture block includes a plurality of fixtures and each fixture is associated with the same product.

4. A method for managing a plurality of retail stores, the method comprising:
generating, at a central server, an interactive floor map for each of the plurality of stores, wherein the interactive floor map specifies an arrangement of products to be displayed in the store;
communicating, by the central server, the interactive floor map to an in-store server, located in each of the plurality of stores, in advance of an effective date and an effective time;
communicating, by the central server to the in-store server, the effective date associated with the interactive floor map, wherein the effective date and effective time are based on a time zone associated with location of each of the plurality of stores; and
receiving, by the central server from the in-store server in each of the plurality of stores prior to the effective date and the effective time, a confirmation that the interactive floor map will be implemented in that store as of the effective date and the effective time.

5. The method of claim 4 wherein generating the interactive floor map includes:
defining a plurality of fixture blocks wherein each fixture block includes a display surface, an arrangement of products on the display surface, and dynamic signage devices associated with each of the products;
selecting a floor plan, the floor plan being associated with at least one of the stores;
arranging the plurality of fixture blocks on the floor plan to produce the interactive floor map for the store; and
automatically associating the interactive floor map with the store.

6. The method of claim 4 wherein the interactive floor map includes metadata associated with each product specified therein, the metadata including an SKU number for the product and wherein the metadata is displayable in response to a user request.

7. The method of claim 4 wherein the plurality of stores are located in multiple times zones across the world.

8. A method for creating an interactive floor map for a retail store, the method comprising:
receiving, at a server, information about one or more products to be displayed in the retail store,
generating, by the server, a plurality of fixtures, each fixture including representation of a product and representation of a dynamic signage device associated with the product,
generating, based on an user input, by the server, a plurality of fixture blocks, each fixture block including one or more fixtures;
receiving, by the server, additional information for a fixture or a fixture block;
associating, by the server, the additional information with the fixture or the fixture block; and
generating, by the server, the interactive floor map including the plurality of fixture blocks and the additional information.

9. The method of claim 8 wherein the additional information includes instructions for configuring a product represented in the fixture or fixture block.

10. The method of claim 8 further comprising specifying a date and time at which the interactive floor map is to be activated for the retail store.

11. The method of claim 10 wherein the date and the time is specified based on a local time zone of a location of the retail store.

12. The method of claim 8 further comprising associating additional information with any one of: the product, the fixture, or the fixture block, the additional information including a specific action to be performed for the associated product, the fixture, or the fixture block.

13. The method of claim 12 wherein the specific action includes instructions for positioning the product, the fixture, or the fixture block based one or more criteria.

14. A computer server comprising:
a processor; and
a memory device for storing a plurality of instructions executable by the processor, wherein the processor is configured to:
receive floor information about a retail store floor, the floor information including dimensions and orientation of the retail store floor;
receive information about a product from a product data store;
receive information about a dynamic signage device to be associated with the product;
generate a fixture including a representation of the product and a representation of the dynamic signage device;
organize a plurality of fixtures into a fixture block;
receive input to arrange a plurality of fixture blocks based on the floor information of the retail store floor; and
generate an interactive floor map for the retail store floor, the interactive floor map including the floor information and the plurality of fixture blocks.

15. The computer server of claim 14 wherein each fixture block includes representations of a plurality of fixtures arranged in a particular orientation.

16. The computer server of claim 14 wherein each fixture block includes a plurality of fixtures and each fixture is associated with the same product.

17. The computer server of claim 14 wherein each fixture block includes a display surface, an arrangement of products on the display surface, and dynamic signage devices associated with each of the products.

18. The computer server of claim 14 wherein the interactive floor map includes metadata associated with each product specified therein, the metadata including an SKU number for the product and wherein the metadata is displayable in response to a user request.
